(19) United States
(12) Patent Application Publication
(10) Pub. No.: US 2026/0352128 A1
(43) Pub. Date: Nov. 5, 2026

(54) ELECTRIC WORK MACHINE

(71) Applicant: MAKITA CORPORATION, Anjo-shi (JP)

(72) Inventors: Shu ISAKA, Anjo-shi (JP); Yuki MATSUMOTO, Anjo-shi (JP); Shin TSUJITA, Anjo-shi (JP); Yuya MATSUYAMA, Anjo-shi (JP)

(73) Assignee: MAKITA CORPORATION, Anjo-shi (JP)

(21) Appl. No.: 19/658,190

(22) Filed: Apr. 24, 2026

(30) Foreign Application Priority Data
Apr. 30, 2025 (JP) 2025-075593

(51) Int. Cl. H02P 21/22; B27B 17/02; B27B 17/08; H02P 21/16; H02P 21/18

(52) U.S. Cl. CPC H02P 21/22; H02P 21/16; H02P 21/18; B27B 17/02; B27B 17/08

(57) ABSTRACT

An electric work machine includes a brushless DC motor, and a controller configured to control the brushless DC motor. The electric work machine further includes a setter configured to set a limit value of a line current. The controller controls the brushless DC motor such that a line current equal to or less than the limit value set by the setter is input to the brushless DC motor. The setter changes the limit value based on a state of the electric work machine.

### CROSS-REFERENCE TO RELATED APPLICATIONS

This application claims the benefit of Japanese Patent Application No. 2025-075593 filed on Apr. 30, 2025, with the Japan Patent Office, the entire disclosure of which is incorporated herein by reference.

### BACKGROUND

The present disclosure relates to an electric work machine.

Japanese Unexamined Patent Application Publication No. 10-328952 discloses a screw tightening method and a screw tightening device in which a permanent magnet synchronous motor is controlled by field-oriented control (FOC). This screw tightening device is configured to independently perform speed priority control and torque priority control.

In the case of the speed priority control, the screw tightening device performs speed control with priority over torque control. In the case of the torque priority control, the screw tightening device performs the torque control with priority over the speed control. In an initial stage of screw tightening, the screw tightening is performed at a high speed by the speed priority control. In a later stage of the screw tightening, a screw is tightened with an appropriate torque by the torque priority control.

### SUMMARY

In a permanent magnet motor driven by an inverter, there are theoretical limits to an available current and an available voltage. In a conventional technique, the motor is controlled such that the limits are not exceeded. However, an electric work machine is used in various states. The limits change depending on a change in the state.

If an upper limit of an available current is set low assuming the change in the state, a time period during which the motor is driven with an unnecessarily low current becomes longer under the constraint on the set upper limit. On the other hand, if the upper limit is set high, a situation where an actual limit is lower than the set upper limit may occur, and an operation of the electric work machine may become unstable.

Therefore, in one aspect of the present disclosure, it is desirable to provide a technique capable of appropriately setting a limit value of a line current of a motor based on a state of an electric work machine.

In one aspect of the present disclosure, an electric work machine is provided. The electric work machine includes a brushless DC motor, a controller, and a setter. The brushless DC motor may be provided to drive a working portion.

The controller is configured to control the brushless DC motor. The setter is configured to set the limit value of the line current.

In one aspect of the present disclosure, the controller is configured to control the brushless DC motor such that a line current equal to or less than the limit value set by the setter is input to the brushless DC motor. In one aspect of the present disclosure, the setter is configured to change the limit value based on a state of the electric work machine.

With the electric work machine configured in this way, it is possible to appropriately set the limit value of the line current of the motor based on the state of the electric work machine.

### BRIEF DESCRIPTION OF THE DRAWINGS

Hereinafter, some embodiments of the present disclosure will be described as examples with reference to the accompanying drawings.

FIG. 1 is a perspective view of an electric work machine.

FIG. 2 is a diagram illustrating an electrical configuration of the electric work machine.

FIG. 3 is a functional block diagram illustrating a configuration of a control circuit.

FIG. 4 is a functional block diagram illustrating a configuration of a speed controller.

FIG. 5 is a functional block diagram illustrating a configuration of a limit value setter.

FIG. 6 is a diagram illustrating an N-T characteristic.

FIG. 7 is a flowchart illustrating a main process performed by the control circuit (e.g., a processor).

FIG. 8 is a flowchart illustrating a state determination process performed by the control circuit.

FIG. 9 is a flowchart illustrating a limit value setting process performed by the control circuit.

FIG. 10 is a flowchart illustrating an interrupt process performed by the control circuit.

FIGS. 11A and 11B are diagrams illustrating the N-T characteristic according to first modification.

FIG. 12 is a flowchart illustrating a switching process performed by the control circuit according to the first modification.

FIG. 13 is a functional block diagram illustrating a part of the limit value setter according to a second modification.

### DETAILED DESCRIPTION OF EXEMPLARY EMBODIMENTS

### 1. Summary of Embodiments

In an embodiment, an electric work machine is provided. The electric work machine may include at least one of:
Feature 1: the electric work machine includes a motor;
Feature 2: the motor is a brushless DC motor;
Feature 3: the motor is a motor for driving a working portion;
Feature 4: the electric work machine includes a controller;
Feature 5: the controller is configured to control the motor;
Feature 6: the electric work machine includes a setter;
Feature 7: the setter is configured to set a limit value of a line current;
Feature 8: the controller is configured to control the motor based on the limit value set by the setter;
Feature 9: the controller is configured to control the motor such that a line current equal to or less than the limit value set by the setter is input to the motor; and
Feature 10: the setter is configured to change the limit value.

In the electric work machine including at least Feature 10, the limit value of the line current can be changed. In one embodiment, in addition to or in place of at least one of Features 1 through 10, the electric work machine may include:
Feature 11: the setter is configured to change the limit value based on a state of the electric work machine.

In the electric work machine including at least Feature 11, the limit value of the line current of the motor can be appropriately set based on the state of the electric work machine. Thus, it is possible to reduce the occurrence of a situation where the capability of the motor cannot be effectively utilized due to the limit value being lower than the actual limit. Furthermore, it is also possible to effectively utilize the capability of the motor while ensuring safety. As a result, the product performance of the electric work machine can be improved.

In one embodiment, in addition to or in place of at least one of Features 1 through 11, the electric work machine may include at least one of:
Feature 12: the setter is configured to set, as the limit value, a value based on a battery attached to the electric work machine; and
Feature 13: the setter is configured to set, as the limit value, a value based on a state of the battery attached to the electric work machine.

In the electric work machine including at least Feature 12 or 13, the limit value of the line current of the motor can be appropriately set based on the battery or the state of the battery.

In one embodiment, in addition to or in place of at least one of Features 1 through 13, the electric work machine may include at least one of:
Feature 14: the setter is configured to set, as the limit value, a value based on a type of the battery attached to the electric work machine;
Feature 15: the setter is configured to set, as the limit value, a value based on an electrical parameter of the battery attached to the electric work machine;
Feature 16: the state of the battery includes a state based on the type of the battery; and
Feature 17: the state of the battery includes a state based on the electrical parameter of the battery, such as an internal impedance.

In one embodiment, in addition to or in place of at least one of Features 1through 17, the electric work machine may include at least one of:
Feature 18: the setter is configured to set, as the limit value, a value based on an upper limit of a battery current;
Feature 19: the setter is configured to set, as the limit value, a value based on the upper limit of the battery current in an electric power supply system for the motor;
Feature 20: the setter is configured to set, as the limit value, a value based on an upper limit of an input; and
Feature 21: the setter is configured to set, as the limit value, a value based on the upper limit of the input to the motor.

In the electric work machine including at least Feature 18 or 19, the limit value of the line current of the motor can be appropriately set based on the upper limit of the battery current. The battery current may be a current supplied from a battery. The battery current may be a current supplied from the battery attached to the electric work machine. The upper limit of the battery current may change due to replacement of the battery attached to the electric work machine. Setting the limit value based on the upper limit of the battery current contributes to effectively utilizing the capability of the motor within the constraints on allowable input energy.

In the electric work machine including at least Feature 20 or 21, the limit value of the line current of the motor can be appropriately set based on the upper limit of the input. The upper limit of the input may correspond to the upper limit of the battery current. The upper limit of the input may change due to replacement of the battery attached to the electric work machine. Setting the limit value based on the upper limit of the input contributes to effectively utilizing the capability of the motor within the constraints on allowable input energy.

In one embodiment, in addition to or in place of at least one of Features 1 through 21, the electric work machine may include at least one of:
Feature 22: the setter is configured to set, as the limit value, a value based on an upper limit of an output; and
Feature 23: the setter is configured to set, as the limit value, a value based on the upper limit of the output of the motor.

In the electric work machine including at least Feature 22 or 23, the limit value of the line current of the motor can be appropriately set based on the upper limit of the output. An upper limit of the line current corresponding to the upper limit of the output may change due to, for example, a change in a rotational speed of the motor. Setting the limit value based on the upper limit of the output contributes to effectively utilizing the capability of the motor within the constraints on allowable output energy.

In one embodiment, in addition to or in place of at least one of Features 1 through 23, the electric work machine may include at least one of:
Feature 24: the setter is configured to set, as the limit value, a value based on an upper limit of a torque; and
Feature 25: the setter is configured to set, as the limit value, a value based on the upper limit of the torque of the motor.

In the electric work machine including at least Feature 24 or 25, the limit value of the line current of the motor can be appropriately set based on the upper limit of the torque. The upper limit of the line current corresponding to the upper limit of the torque may change due to, for example, a change in the rotational speed of the motor. Setting the limit value based on the upper limit of the torque contributes to effectively utilizing the capability of the motor within the constraints on allowable torque.

In one embodiment, in addition to or in place of at least one of Features 1 through 25, the electric work machine may include at least one of:
Feature 26: the setter is configured to set, as the limit value, a value based on a temperature; and
Feature 27: the setter is configured to set, as the limit value, a value based on a temperature of the motor.

The actual limit of the line current may change due to, for example, a change in the temperature of the motor. In the electric work machine including at least Feature 26 or 27, the limit value of the line current of the motor can be appropriately set based on the change in the temperature of the motor. The electric work machine including at least Feature 26 or 27 contributes to effectively utilizing the capability of the motor under changing temperatures.

In one embodiment, in addition to or in place of at least one of Features 1 through 27, the electric work machine may include at least one of:
Feature 28: the electric work machine includes an inverter; and
Feature 29: the setter is configured to set, as the limit value, a value based on a temperature of the inverter.

The inverter may be configured to input the line current to the motor. An allowable current value of the inverter may change due to, for example, a change in the temperature of the inverter. In the electric work machine including al least Feature 29, the limit value can be appropriately set based on the change in the temperature of the inverter.

In one embodiment, in addition to or in place of at least one of Features 1 through 29, the electric work machine may include at least one of:
Feature 30: the setter is configured to estimate a loss in electric power;
Feature 31: the setter is configured to estimate the loss in electric power to be input to the motor;
Feature 32: the setter is configured to set the limit value based on the loss in electric power; and
Feature 33: the setter is configured to estimate the loss in electric power to be input to the motor, and set the limit value based on the estimated loss.

The electric work machine including at least one of Features 30 through 33 sets the limit value based on the loss in electric power, and therefore contributes to effectively utilizing the capability of the motor.

In one embodiment, in addition to or in place of at least one of Features 1 through 33, the electric work machine may include:
Feature 34: the setter is configured to estimate the loss in electric power based a resistance of the motor.

In one embodiment, in addition to or in place of at least one of Features 1 through 34, the electric work machine may include:
Feature 35: the setter is configured to estimate the resistance of the motor based on the temperature of the motor.

A magnitude of the loss in electric power may change depending on the resistance of the motor. In the electric work machine including at least Feature 34 or 35, the limit value of the line current can be appropriately set based on a change in the resistance of the motor. The electric work machine including at least Feature 34 or 35 contributes to effectively utilizing the capability of the motor under the changing resistance of the motor.

In one embodiment, in addition to or in place of at least one of Features 1 through 35, the electric work machine may include:
Feature 36: the setter is configured to set the limit value based on a rotational speed of the motor.

The upper limit of the line current of the motor may change based on a change in the rotational speed of the motor. The electric work machine including at least Feature 36 sets the limit value based on the rotational speed, and therefore contributes to effectively utilizing the capability of the motor.

In one embodiment, in addition to or in place of at least one of Features 1 through 36, the electric work machine may include at least one of:
Feature 37: the setter is configured to set, as the limit value, one of a first limit value, a second limit value, and a third limit value, the first limit value being based on an upper limit of a battery current, the second limit value being based on an upper limit of an output, and the third limit value being based on an upper limit of a torque;
Feature 38: the setter is configured to set, as the limit value, one limit value satisfying a specified condition among the first limit value, the second limit value, and the third limit value, the first limit value being based on the upper limit of the battery current, the second limit value being based on the upper limit of the output, and the third limit value being based on the upper limit of the torque;
Feature 39: the setter is configured to set, as the limit value, a minimum value among the first limit value, the second limit value, and the third limit value, the first limit value being based on the upper limit of the battery current, the second limit value being based on the upper limit of the output, and the third limit value being based on the upper limit of the torque;
Feature 40: the upper limit of the battery current is the upper limit of the battery current in the electric power supply system for the motor;
Feature 41: the upper limit of the output is the upper limit of the output of the motor; and
Feature 42: the upper limit of the torque is the upper limit of the torque of the motor.

The electric work machine including at least one of Features 37 through 39 sets the limit value in consideration of a plurality of constraints, and therefore can appropriately set the limit value depending on a situation. Therefore, the electric work machine contributes to effectively utilizing the capability of the motor.

In one embodiment, in addition to or in place of at least one of Features 1 through 42, the electric work machine may include at least one of:
Feature 43: the controller is configured to switch a control on the motor;
Feature 44: the controller is configured to perform a constant output control on motor;
Feature 45: the controller is configured to perform a torque limitation on the motor;
Feature 46: the controller is configured to switch and perform a plurality of controls including the constant output control and the torque limitation on the motor;
Feature 47: the controller is configured to switch the control on the motor in response to an increase in a load applied to the motor;
Feature 48: the controller is configured to switch and perform a plurality of controls including the constant output control and the torque limitation of the motor in response to the increase in the load applied to the motor;
Feature 49: in response to the increase in the load applied to the motor, the controller is configured to (i) perform the constant output control on the motor in a first stage, and (ii) perform the torque limitation on the motor in a second stage;
Feature 50: the controller is configured to perform the constant output control on the motor in the first stage such that the rotational speed of the motor varies in inverse proportion to the torque of the motor;
Feature 51: the controller is configured to perform the torque limitation on the motor in the second stage such that the torque of the motor does not exceed a specified value regardless of the rotational speed of the motor; and
Feature 52: the controller is configured to perform the torque limitation on the motor in the second stage such that the torque of the motor varies monotonically with the rotational speed of the motor.

The monotonic change may include a monotonic increase and a monotonic decrease in a broad sense. The electric work machine including at least one of Features 43 through 52 can perform an appropriate motor control depending on the state of the electric work machine. That is, at least one of Features 43 through 52 can improve a performance of the electric work machine.

In one embodiment, in addition to or in place of at least one of Features 1through 52, the electric work machine may include at least one of:
Feature 53: the controller is configured to switch a form of the control on the motor in accordance with an instruction from a user; and
Feature 54: the controller is configured to switch a form of the torque limitation on the motor in accordance with the instruction from the user.

The electric work machine including at least one of Features 53 and 54 is capable of performing motor control that matches an operational feel desired by the user.

In one embodiment, in addition to or in place of at least one of Features 1 through 54, the electric work machine may include at least one of:
Feature 55: in an environment in which the setter sets the limit value based on the upper limit of the torque, the torque limitation is achieved by controlling the motor such that a line current based on the limit value is input to the motor; and
Feature 56: in an environment in which the setter sets the limit value based on the upper limit of the torque of the motor, the torque limitation is achieved by controlling the motor such that a line current based on the limit value is input to the motor.

The electric work machine including at least Feature 55 or 56 is capable of appropriately performing the torque limitation on the motor through the setting of the limit value.

In one embodiment, in addition to or in place of at least one of Features 1 through 56, the electric work machine may include at least one of:
Feature 57: in an environment in which the setter sets the limit value based on the upper limit of the battery current, the constant output control is achieved by controlling the motor;
Feature 58: in the environment in which the setter sets the limit value based on the upper limit of the battery current, the constant output control is achieved by controlling the motor such that a line current based on the limit value is input to the motor;
Feature 59: in an environment in which the setter sets the limit value based on the upper limit of the output, the constant output control is achieved by controlling the motor;
Feature 60: in the environment in which the setter sets the limit value based on the upper limit of the output, the constant output control is achieved by controlling the motor such that a line current based on the limit value is input to the motor;
Feature 61: in an environment in which the setter sets the limit value based on the upper limit of the battery current in the electric power supply system for the motor or the upper limit of the output of the motor, the constant output control is achieved by controlling the motor; and
Feature 62: in the environment in which the setter sets the limit value based on the upper limit of the battery current in the electric power supply system for the motor or the upper limit of the output of the motor, the constant output control is achieved by controlling the motor such that a line current based on the limit value is input to the motor.

The electric work machine including at least one of Features 57 through 62 is capable of appropriately performing the constant output control on the motor through the setting of the limit value.

In one embodiment, in addition to or in place of at least one of Features 1 through 62, the electric work machine may include at least one of:
Feature 63: the controller is configured to perform a constant rotation control on the motor such that the motor rotates at a constant speed;
Feature 64: the controller is configured to (i) perform the constant rotation control on the motor such that the motor rotates at a constant speed, and (ii) perform the constant output control on the motor in response to the increase in the load applied to the motor;
Feature 65: the controller is configured to (i) perform the constant rotation control on the motor such that the motor rotates at a constant speed, and (ii) perform the torque limitation on the motor in response to the increase in the load applied to the motor; and
Feature 66: the controller is configured to (i) perform the constant rotation control on the motor such that the motor rotates at a constant speed, and (ii) perform the constant output control and the torque limitation on the motor in response to the increase in the load applied to the motor.

The electric work machine including at least one of Features 64 through 66 switches the control on the motor from the constant rotation control to the constant output control and/or the torque limitation in response to the increase in the load applied to the motor. Therefore, it is possible to drive the motor under various constraints including an energy constraint and/or a torque constraint, while effectively utilizing the capability of the motor.

In one embodiment, in addition to or in place of at least one of Features 1 through 66, the electric work machine may include at least one of:
Feature 67: the controller is configured to drive the motor by field-oriented control; and
Feature 68: the controller is configured to drive the motor by controlling an inverter.

The electric work machine including at least Feature 67 or 68 can drive the motor by field-oriented control under the various constraints, while effectively utilizing the capability of the motor.

In one embodiment, the electric work machine may include one or more of Features 1 through 68. In one embodiment, the electric work machine may include a feature corresponding to a combination of any two or more of Features 1 through 68. In one embodiment, the electric work machine does not necessarily include one or more of Features 1 through 68.

### 2. Specific Example Embodiments

Hereinafter, some specific example embodiments are provided below.

### 2-1. Main Embodiment

This embodiment exemplifies an electric work machine 1. Hereinafter, the electric work machine 1 is simply referred to as a work machine 1. The work machine 1 of this embodiment is an electric chain saw. However, the electric chain saw is merely an example, and the present disclosure can be applied to any form of electric work machine.

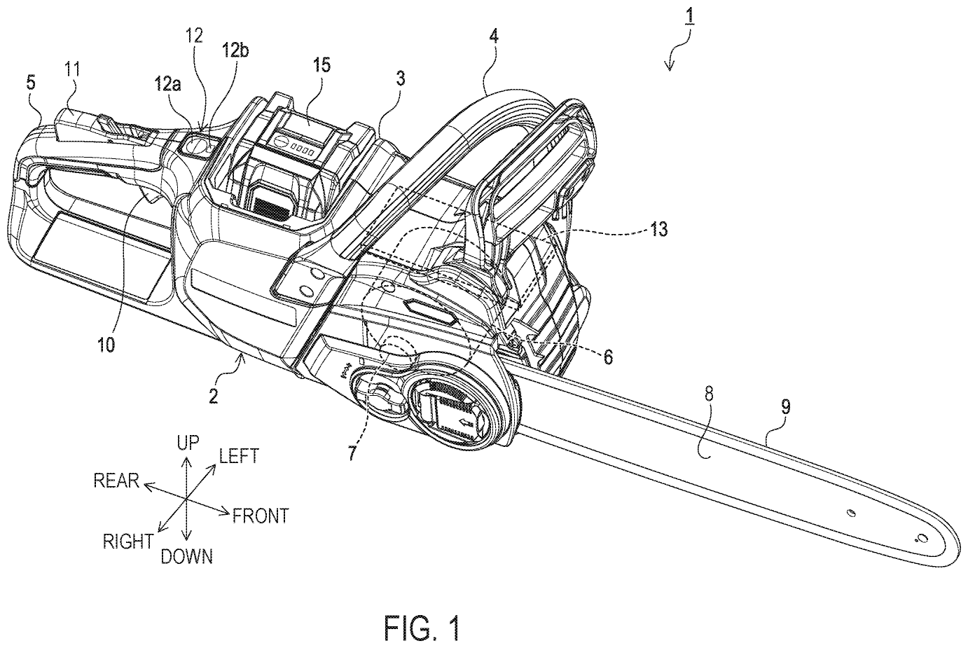

FIG. 1 shows directions such as “up,” “down,” “front,” “rear,” “left,” and “right”. However, these directions are only shown to facilitate a better understanding of the structure of the work machine 1, and are not intended to limit the orientation of the work machine 1. The work machine 1 can be arranged in any orientation.

### 2-1-1. Mechanical Structure of Work Machine

The work machine 1 shown in FIG. 1 includes a housing 2. The housing 2 houses a motor 6, a power transmission mechanism 7, and a controller 13 inside.

The work machine 1 includes a guide bar 8. The guide bar 8 is a plate-shaped member. The guide bar 8 protrudes from the housing 2 in a forward direction of the work machine 1. The work machine 1 includes a saw chain 9. The saw chain 9 includes a plurality of cutters connected to each other. The saw chain 9 is detachably attached to a peripheral edge of the guide bar 8.

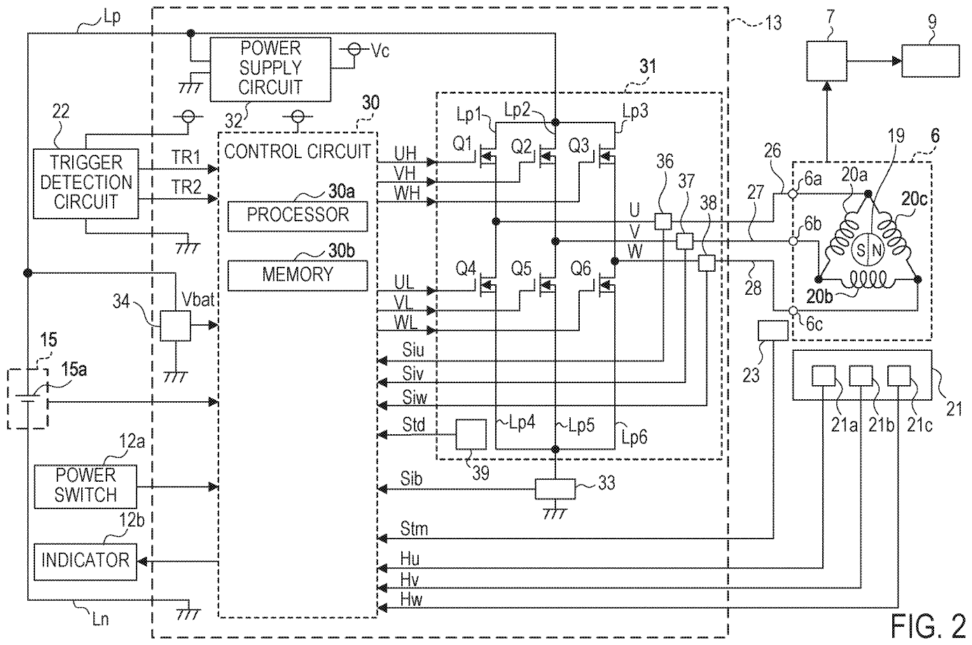

The power transmission mechanism 7 is directly or indirectly connected to the motor 6 (specifically, a rotor 19; see FIG. 2). The power transmission mechanism 7 includes a sprocket (not shown) configured to receive the saw chain 9 thereon. The power transmission mechanism 7 transmits the rotation of the motor 6 (specifically, the rotation of the rotor 19) to the saw chain 9 to thereby drive the saw chain 9.

When the motor 6 is driven, the saw chain 9 moves along the peripheral edge of the guide bar 8. Such movement enables the saw chain 9 to perform an operation on a workpiece. Specifically, the saw chain 9 can cut a workpiece such as wood, metal, or resin. The saw chain 9 is an example of a working portion. The motor 6 is a motor for driving the saw chain 9.

The housing 2 includes a battery port 3 at a rear part thereof. The battery port 3 is where a battery pack 15 is detachably attached. Multiple types of battery packs 15, such as battery packs having different capacities and/or outputs, can be attached to the battery port 3 by replacement. FIG. 1 shows a state in which the battery pack 15 is attached to the battery port 3.

The battery pack 15 houses a rechargeable battery 15a (see FIG. 2). The battery 15a includes, for example, a lithium-ion battery. While the battery pack 15 is attached to the battery port 3, electric power from the battery 15a can be supplied to various components of the work machine 1.

The work machine 1 includes a front handle 4 on an upper part of the housing 2. The front handle 4 is gripped by a user of the work machine 1. The work machine 1 includes a rear handle 5 at a rear part of the housing 2. The rear handle 5 is gripped by the user. For example, the user can use the work machine 1 while gripping the front handle 4 with one hand (e.g., a left hand) and gripping the rear handle 5 with the other hand (e.g., a right hand).

The work machine 1 includes a trigger 10. The trigger 10 is manually operated by the user. Specifically, the trigger 10 is manually pulled upward. When the trigger 10 is manually operated (i.e., pulled), the motor 6 is driven. In the present embodiment, the trigger 10 is provided on the rear handle 5. Therefore, the user can manually operate the trigger 10 while gripping the rear handle 5.

The work machine 1 includes a lock-off lever 11 in the vicinity of the trigger 10. The lock-off lever 11 is manually operated (e.g., pushed downward) by the user. When the lock-off lever 11 is not manually operated by the user, the lock-off lever 11 restricts movement of the trigger 10. While the lock-off lever 11 is manually operated by the user, the restriction on the trigger 10 is released, and the user can manually operate the trigger 10. In the present embodiment, the lock-off lever 11 is provided on the rear handle 5. Therefore, the user can manually operate the trigger 10 while gripping the rear handle 5 and manually operating the lock-off lever 11.

The work machine 1 includes an operation panel 12. In the present embodiment, the operation panel 12 is arranged on an upper surface in a rear end part of the housing 2. The operation panel 12 includes a power switch 12a and an indicator 12b.

The power switch 12a of the present embodiment is in the form of a momentary switch. The power switch 12a outputs an operation signal while the power switch 12a is pressed. The power switch 12a does not output the operation signal while the power switch 12a is not pressed.

The indicator 12b visually notifies the user of the state of the work machine 1. T indicator 12b of the present embodiment includes an LED (not shown). In the following description, “turning on” and “turning off” of the indicator 12b mean “turning on” and “turning off” of the LED.

### 2-1-2. Electrical Configuration of Work Machine

An electrical configuration of the work machine 1 will be described with reference to FIG. 2. The work machine 1 includes the motor 6 and the controller 13 described above.

In the present embodiment, the motor 6 is an inner-rotor brushless DC motor (specifically, a three-phase brushless DC motor). In another embodiment, the motor 6 may be any other type of brushless DC motor (e.g., an outer-rotor brushless DC motor).

The motor 6 includes a first coil 20a, a second coil 20b, and a third coil 20c. The first through third coils 20a, 20b, and 20c are connected to each other in a delta configuration. However, the first through third coils 20a, 20b, and 20c may be connected to each other in a manner different from the delta configuration. The first through third coils 20a, 20b, and 20c may be, for example, connected to each other in a star configuration.

The motor 6 includes a stator (not shown), and the first through third coils 20a, 20b, and 20c are included in the stator. The stator includes teeth (not shown), and the first through third coils 20a, 20b, and 20c are respectively wound around the teeth.

The motor 6 includes a rotor 19. The rotor 19 is arranged so as to pass through the stator, and is rotatably supported by a bearing (not shown). The rotor 19 has a plurality of magnetic poles along a rotational direction. Specifically, in the rotor 19, N poles and S poles are alternately arranged along the rotational direction. In the rotor 19 of FIG. 2, “N” schematically indicates an N pole, and “S” schematically indicates an S pole.

For simplicity of description, FIG. 2 schematically shows the motor 6 as if it were a brushless DC motor in the form of two poles and three slots (i.e., three teeth). However, the motor 6 of the present disclosure actually has four or more magnetic poles and six or more slots (i.e., six or more teeth). Of course, the motor 6 may actually be in the form of two poles and three slots.

The motor 6 includes a first terminal 6a, a second terminal 6b, and a third terminal 6c. The first terminal 6a is connected to a first end of the first coil 20a and a first end of the third coil 20c. The second terminal 6b is connected to a second end of the first coil 20a and a first end of the second coil 20b. The third terminal 6c is connected to a second end of the second coil 20b and a second end of the third coil 20c.

The work machine 1 includes a position signal output circuit 21. The position signal output circuit 21 is arranged in the vicinity of the motor 6 (specifically, in the vicinity of the rotor 19). The position signal output circuit 21 includes a first rotation sensor 21a, a second rotation sensor 21b, and a third rotation sensor 21c. In the present embodiment, each of the first through third rotation sensors 21a through 21c is a Hall sensor, but is not limited thereto.

The first through third rotation sensors 21a through 21c are arranged to be spaced apart from the rotor 19 by a specified distance in a direction along a rotational axis thereof. The first through third rotation sensors 21a through 21c are arranged to be spaced apart from each other by an electrical angle of 120 degrees along the rotational direction of the rotor 19.

The first rotation sensor 21a outputs a first Hall signal Hu, the second rotation sensor 21b outputs a second Hall signal Hv, and the third rotation sensor 21c outputs a third Hall signal Hw. The first through third Hall signals Hu, Hv, and Hw are each in the form of a digital signal (i.e., a binary signal). The respective logical values of the first through third Hall signals Hu, Hv, and Hw are inverted every time the rotor 19 rotates by an electrical angle of 180 degrees. The phases of the first through third Hall signals Hu, Hv, and Hw are shifted from each other by an electrical angle of 120 degrees.

The work machine 1 includes a power supply line Lp. The power supply line Lp extends from a positive electrode of the battery pack 15 attached to the battery port 3 to the controller 13. The work machine 1 includes a ground line Ln. The ground line Ln extends from a negative electrode of the battery pack 15 attached to the battery port 3 to the controller 13. The battery pack 15 applies a voltage Vbat (hereinafter referred to as “battery voltage”) from the battery 15a between the power supply line Lp and the ground line Ln.

The controller 13 includes a power supply circuit 32. The power supply circuit 32 is connected to the power supply line Lp, and receives the battery voltage Vbat via the power supply line Lp. The power supply circuit 32 generates a DC voltage (hereinafter referred to as “power supply voltage”) Vc based on the battery voltage Vbat.

The controller 13 includes a control circuit 30. The control circuit 30 operates by receiving the power supply voltage Vc. The control circuit 30 is a microcomputer including a processor 30a and a memory 30b.

The memory 30b is in the form of a semiconductor memory. The memory 30b includes a ROM, a RAM, and a rewritable nonvolatile memory. The nonvolatile memory is, for example, an EEPROM, a flash memory, a ReRAM, an FeRAM, or the like. Various functions of the control circuit 30 are achieved by the processor 30a executing a computer program stored in the memory 30b.

In another embodiment, the control circuit 30 may include an additional microcomputer. In still another embodiment, a part or all of the functions achieved by the processor 30a may be achieved by one or more electronic components (e.g., an integrated circuit). In still another embodiment, the control circuit 30 may be a logic circuit (or a wired logic connection) including two or more electronic components. In still another embodiment, the control circuit 30 may include an ASIC and/or an ASSP. In still another embodiment, the control circuit 30 may include a programmable logic device in which a reconfigurable logic circuit can be constructed. Examples of the programmable logic device include an FPGA.

The controller 13 includes a drive circuit 31. The drive circuit 31 is electrically connected to the power supply line Lp and the ground line Ln, and receives the battery voltage Vbat via the power supply line Lp and the ground line Ln.

The drive circuit 31 is electrically connected to the motor 6 via a first lead wire 26, a second lead wire 27, and a third lead wire 28. Specifically, the first lead wire 26 is connected to the first terminal 6a of the motor 6. The second lead wire 27 is connected to the second terminal 6b of the motor 6. The third lead wire 28 is connected to the third terminal 6c of the motor 6.

The drive circuit 31 functions as an inverter. The drive circuit 31 generates a three-phase voltage (i.e., generates three-phase electric power) from the battery voltage Vbat. The drive circuit 31 supplies the generated three-phase voltage to the motor 6 via the first through third lead wires 26 through 28.

In the following description, a current flowing through the first lead wire 26 is referred to as a U-phase line current, a current flowing through the second lead wire 27 is referred to as a V-phase line current, and a current flowing through the third lead wire 28 is referred to as a W-phase line current. The U-phase line current, the V-phase line current, and the W-phase line current supplied from the drive circuit 31 to the motor 6 each correspond to a line current input to the motor 6.

The drive circuit 31 of the present embodiment is a three-phase full-bridge circuit, but is not limited thereto. The drive circuit 31 includes first through third current paths Lp1 through Lp3 as so-called upper arms. The first through third current paths Lp1 through Lp3 electrically connect the power supply line Lp to the first through third terminals 6a, 6b, and 6c of the motor 6, respectively.

The drive circuit 31 includes fourth through sixth current paths Lp4 through Lp6 as so-called lower arms. The fourth through sixth current paths Lp4 through Lp6 electrically connect the ground line Ln to the first through third terminals 6a, 6b, and 6c of the motor 6, respectively.

The drive circuit 31 includes a first switch Q1 on the first current path Lp1, a second switch Q2 on the second current path Lp2, a third switch Q3 on the third current path Lp3, a fourth switch Q4 on the fourth current path Lp4, a fifth switch Q5 on the fifth current path Lp5, and a sixth switch Q6 on the sixth current path Lp6.

Each of the first through third switches Q1 through Q3 functions as a so-called high-side switch. Each of the fourth through sixth switches Q4 through Q6 functions as a so-called low-side switch. The first through third current paths Lp1 through Lp3 are completed or interrupted by the first through third switches Q1 through Q3, respectively. The fourth through sixth current paths Lp4 through Lp6 are completed or interrupted by the fourth through sixth switches Q4 through Q6, respectively.

The first through sixth switches Q1 through Q6 are semiconductor switches. In the present embodiment, the first through sixth switches Q1 through Q6 are in the form of n-channel metal-oxide-semiconductor field-effect transistors (MOSFETs). However, the first through sixth switches Q1 through Q6 may be other forms of semiconductor switches, for example, bipolar transistors, insulated gate bipolar transistors (IGBTs), or the like.

The first switch Q1 receives a first drive signal UH from the control circuit 30, and turns on or off in accordance with the first drive signal UH. The second switch Q2 receives a second drive signal VH from the control circuit 30, and turns on or off in accordance with the second drive signal VH. The third switch Q3 receives a third drive signal WH from the control circuit 30, and turns on or off in accordance with the third drive signal WH. The fourth switch Q4 receives a fourth drive signal UL from the control circuit 30, and turns on or off in accordance with the fourth drive signal UL. The fifth switch Q5 receives a fifth drive signal VL from the control circuit 30, and turns on or off in accordance with the fifth drive signal VL. The sixth switch Q6 receives a sixth drive signal WL from the control circuit 30, and turns on or off in accordance with the sixth drive signal WL. In the present embodiment, the first through sixth drive signals UH, VH, WH, UL, VL, and WL may be pulse width modulated signals.

When the motor 6 is driven, basically, one of the high-side switches and one of the low-side switches are turned on. As a result, a current flows from the positive electrode of the battery pack 15 through the high-side switch, the motor 6, and the low-side switch to the negative electrode of the battery pack 15, whereby the motor 6 rotates. This current corresponds to the battery current Ibat.

The drive circuit 31 includes a first current detection circuit 36 on the first lead wire 26. The first current detection circuit 36 detects the U-phase line current flowing through the first lead wire 26. Specifically, the first current detection circuit 36 outputs a U-phase line current detection signal Siu corresponding to the magnitude of the U-phase line current. The U-phase line current detection signal Siu is input to the control circuit 30.

The drive circuit 31 includes a second current detection circuit 37 on the second lead wire 27. The second current detection circuit 37 detects the V-phase line current flowing through the second lead wire 27. Specifically, the second current detection circuit 37 outputs a V-phase line current detection signal Siv corresponding to the magnitude of the V-phase line current. The V-phase line current detection signal Siv is input to the control circuit 30.

The drive circuit 31 includes a third current detection circuit 38 on the third lead wire 28. The third current detection circuit 38 detects the W-phase line current flowing through the third lead wire 28. Specifically, the third current detection circuit 38 outputs a W-phase line current detection signal Siw corresponding to the magnitude of the W-phase line current. The W-phase line current detection signal Siw is input to the control circuit 30.

The controller 13 includes a battery current detection circuit 33. The battery current detection circuit 33 is on a current path through which the battery current Ibat flows. In the present embodiment, the battery current detection circuit 33 is on the ground line Ln in the controller 13, more specifically, on a current path between the drive circuit 31 and the ground.

The battery current detection circuit 33 detects the battery current Ibat. Specifically, the battery current detection circuit 33 outputs a battery current detection signal Sib corresponding to the magnitude of the battery current Ibat. The battery current detection signal Sib is input to the control circuit 30.

In the present embodiment, the battery current detection circuit 33 is located between the drive circuit 31 (inverter) and the ground, in other words, between the drive circuit 31 (inverter) and the negative electrode of the battery 15a, and measures the battery current Ibat returning to the battery 15a. Therefore, as another example, the battery current detection circuit 33 may be provided between the negative electrode of the battery 15a and the ground. Although the battery current Ibat detected here does not include a capacitor current flowing back and forth between a capacitor (not shown) on the inverter and the motor 6, the term “battery current” is not limited to one that does not include the capacitor current. That is, the term “battery current” should be broadly understood as a term that allows the capacitor current to be included as a component.

The controller 13 further includes a battery voltage detection circuit 34. The battery voltage detection circuit 34 detects a battery voltage Vbat as a potential difference generated across the battery 15a. The battery voltage detection circuit 34 inputs the detected battery voltage Vbat to the control circuit 30.

The controller 13 includes a first temperature detection circuit 39. The first temperature detection circuit 39 is provided in or in the vicinity of the drive circuit 31. The first temperature detection circuit 39 includes a first temperature sensor (not shown). The first temperature sensor is, for example, a thermistor. The first temperature sensor outputs a first temperature detection signal Std corresponding to a temperature around the first temperature sensor. The first temperature detection signal Std is input to the control circuit 30. The first temperature detection signal Std directly or indirectly indicates the temperatures of the first through sixth switches Q1 through Q6 (in other words, the temperature of the drive circuit 31). The first temperature detection circuit 39 is provided to detect the temperature of the drive circuit 31, i.e., the inverter.

The work machine 1 includes a second temperature detection circuit 23. The second temperature detection circuit 23 is provided inside or in the vicinity of the motor 6. The second temperature detection circuit 23 includes a second temperature sensor (not shown). The second temperature sensor is, for example, a thermistor. The second temperature sensor outputs a second temperature detection signal Stm corresponding to a temperature around the second temperature sensor. The second temperature detection signal Stm is input to the control circuit 30. The second temperature detection signal Stm directly or indirectly indicates the temperature of the motor 6. The second temperature detection circuit 23 is provided to detect the temperature of the motor 6. However, the temperature is a parameter that can be estimated as will be described later. For this reason, the installation of the temperature detection circuit is optional. For example, the second temperature detection circuit 23 may be omitted.

The work machine 1 further includes a trigger detection circuit 22. The trigger detection circuit 22 is mechanically connected to the trigger 10, and outputs a first trigger signal TR1 and a second trigger signal TR2 based on a state of the trigger 10. The first trigger signal TR1 is a binary signal indicating whether the trigger 10 is manually operated. For example, while the trigger 10 is not manually operated, the first trigger signal TR1 is at a low level, and while the trigger 10 is manually operated, the first trigger signal TR1 is at a high level. The second trigger signal TR2 is an analog signal corresponding to an amount of movement of the trigger 10 from an initial position (in other words, corresponding to a pull amount).

The first and second trigger signals TR1 and TR2 are input to the control circuit 30. Based on the first and second trigger signals TR1 and TR2, the control circuit 30 can acquire information indicating whether the trigger 10 is turned on (that is, manually operated), and the pull amount of the trigger 10 when the trigger 10 is manually operated.

The above-described power switch 12a and indicator 12b are electrically connected to the control circuit 30. The control circuit 30 receives an operation signal from the power switch 12a. Based on the presence or absence of the operation signal, the control circuit 30 can recognize whether the power switch 12a is pressed.

In the present embodiment, even if the battery pack 15 is attached to the battery port 3, the power-supply voltage Vc is not immediately generated. After the battery pack 15 is attached, the power-supply voltage Vc is generated in response to the power switch 12a being long-pressed, and whereby the control circuit 30 is activated. The long press means, for example, continuing to press the power switch 12a for a first specified time (e.g., 2 to 3 seconds) or longer.

The control circuit 30 controls the indicator 12b (specifically, an LED in the present embodiment) based on a state of the work machine 1. For example, while being activated, the control circuit 30 causes the indicator 12b to turn on in a first manner. The first manner may be, for example, a manner in which the LED is turned on in a first color (e.g., green).

The control circuit 30 receives the first through third Hall signals Hu, Hv, and Hw from the position signal output circuit 21. As described above, the phases of the first through third Hall signals Hu, Hv, and Hw are shifted from each other by 120 electrical degrees. Therefore, every time the rotor 19 rotates by 60 electrical degrees, a logical value of one of the first through third Hall signals Hu, Hv, and Hw changes. Based on the change in the logical value every 60 degrees, the control circuit 30 detects a rotational position (in other words, a rotation angle) and a rotational speed of the motor 6.

The control circuit 30 further receives the above-described first temperature detection signal Std and second temperature detection signal Stm.

The control circuit 30 further receives the above-described U-phase line current detection signal Siu, V-phase line current detection signal Siv, and W-phase line current detection signal Siw.

Based on the various input signals, the control circuit 30 controls the rotation of the motor 6 as will be described later. The control circuit 30 is configured to drive the motor 6 by FOC.

### 2-1-3. Functions of Control Circuit

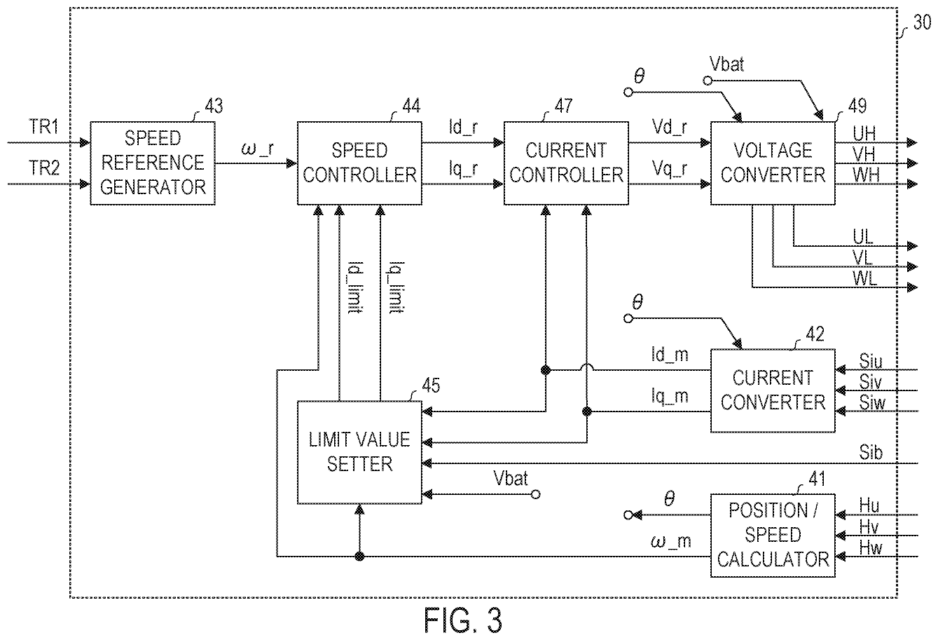

As shown in FIG. 3, the control circuit 30 functions as a position/speed calculator 41, a current converter 42, a speed reference generator 43, a speed controller 44, a limit value setter 45, a current controller 47, and a voltage converter 49. These functions are achieved, for example but not limited to, by the processor 30a executing a computer program stored in the memory 30b.

As another example, the function of at least one of the position/speed calculator 41, the current converter 42, the speed reference generator 43, the speed controller 44, the limit value setter 45, the current controller 47, and the voltage converter 49 may be achieved by hardware (e.g., a dedicated electronic circuit) instead of software. That is, the corresponding hardware may be incorporated in the control circuit 30.

The first through third Hall signals Hu, Hv, and Hw are input to the position/speed calculator 41 from the position signal output circuit 21 (see FIG. 2). Based on the first through third Hall signals Hu, Hv, and Hw, the position/speed calculator 41 calculates a rotation angle θ and a speed measurement value ω_m of the rotor 19. The speed measurement value ω_m is a measured value of a rotational speed of the rotor 19.

A method for calculating the rotation angle θ and the speed measurement value ω_m based on the first through third Hall signals Hu, Hv, and Hw is not limited to a specific method, and, for example, a known method may be adopted. The position/speed calculator 41 inputs the calculated rotation angle θ to the current converter 42 and the voltage converter 49, and inputs the calculated speed measurement value ω_m to the speed controller 44 and the limit value setter 45.

The detection signals of the three-phase line currents of the U, V, and W phases are input to the current converter 42. The detection signals of the three-phase line currents input to the current converter 42 are the U-phase, V-phase, and W-phase line current detection signals Siu, Siv, and Siw from the first through third current detection circuits 36, 37, and 38. The U-phase, V-phase, and W-phase line current detection signals Siu, Siv, and Siw indicate magnitudes of the U-phase, V-phase, and W-phase line currents detected by the first through third current detection circuits 36, 37, and 38, i.e., measurement values of the U-phase, V-phase, and W-phase line currents.

The current converter 42 converts the measurement values of the three-phase line currents of the U, V, and W phases into a d-q axis current (Id_m, Iq_m) in a d-q coordinate system. The d-q axis current (Id_m, Iq_m) is a two-dimensional current vector including a d-axis current Id_m and a q-axis current Iq_m as elements. The current converter 42 may convert the measurement values of the three-phase line currents into the d-axis current Id_m and the q-axis current Iq_m by, for example, Clarke transformation and Park transformation.

The d-q coordinate system is a known rotating coordinate system composed of a d-axis and a q-axis orthogonal to each other. The d-axis represents a magnetic flux direction of a magnetic body of the rotor 19 in the motor 6. The q-axis represents a direction in which torque is generated in the rotor 19. The d-axis current Id_m is a d-axis component of the current vector. The q-axis current Iq_m is a q-axis component of the current vector.

The current converter 42 inputs the converted d-axis current Id_m and q-axis current Iq_m to the limit value setter 45 and the current controller 47. Hereinafter, the d-axis current Id_m and the q-axis current Iq_m output from the current converter 42 are referred to as a d-axis current measurement value Id_m and a q-axis current measurement value Iq_m, respectively.

The first trigger signal TR1 and the second trigger signal TR2 of the trigger 10 are input to the speed reference generator 43. Based on the first trigger signal TR1 and the second trigger signal TR2, the speed reference generator 43 calculates a speed reference value ω_r.

The speed reference value ω_r is a reference value of a rotational speed for the rotor 19. When the first trigger signal TR1 indicates that the trigger 10 is not manually operated, the speed reference generator 43 calculates the speed reference value ω_r=0. When the first trigger signal TR1 indicates that the trigger 10 is manually operated, the speed reference generator 43 calculates the speed reference value ω_r to indicate a larger value with an increase in the pull amount of the trigger 10 indicated by the second trigger signal TR2. The speed reference generator 43 outputs the calculated speed reference value ω_r to the speed controller 44.

The speed reference value ω_r and the speed measurement value ω_m are input to the speed controller 44. A d-axis current limit value Id_limit, which is the limit value of the d-axis current set by the limit value setter 45, is further input to the speed controller 44. A q-axis current limit value Iq_limit, which is the limit value of the q-axis current set by the limit value setter 45, is further input to the speed controller 44.

Based on the speed reference value ω_r and the speed measurement value ω_m, the speed controller 44 calculates a d-axis current reference value Id_r and a q-axis current reference value Iq_r. Specifically, the speed controller 44 calculates the d-axis current reference value Id_r within a range not exceeding the d-axis current limit value Id_limit, and calculates the q-axis current reference value Iq_r within a range not exceeding the q-axis current limit value Iq_limit. The speed controller 44 inputs the calculated d-axis current reference value Id_r and q-axis current reference value Iq_r to the current controller 47.

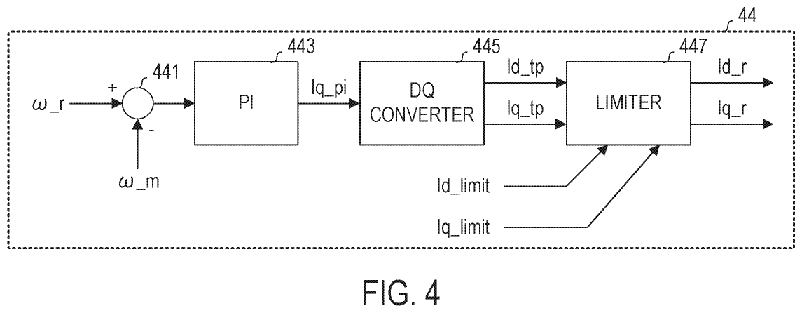

FIG. 4 shows a detailed configuration of the speed controller 44. The speed controller 44 includes a deviation calculator 441, a PI controller 443, a dq converter 445, and a limiter 447. The deviation calculator 441 calculates a speed deviation E=ω_r−ω_m. The speed deviation E is a deviation between the speed reference value ω_r and the speed measurement value ω_m. The speed deviation E is input to the PI controller 443.

The PI controller 443 is configured to output a q-axis current reference value Iq_pi based on the speed deviation E by PI control (Proportional-Integral control). The q-axis current reference value Iq_pi output from the PI controller 443 is input to the dq converter 445.

The dq converter 445 converts the q-axis current reference value Iq_pi into a d-axis current reference value Id_tp and a q-axis current reference value Iq_tp. In one example, the dq converter 445 calculates the d-axis current reference value Id_tp and the q-axis current reference value Iq_tp to perform MTPA (Maximum Torque Per Ampere) control. In one example, the dq converter 445 calculates the d-axis current reference value Id_tp and the q-axis current reference value Iq_tp to perform field weakening control. In one example, the dq converter 445 calculates the d-axis current reference value Id_tp and the q-axis current reference value Iq_tp to perform zero d-axis current control in which a d-axis current is zero.

The dq converter 445 may operate in a plurality of control modes including at least one of an MTPA control mode, a field weakening control mode, and a zero d-axis current control mode. The dq converter 445 may calculate a d-axis current reference value Id_tp and a q-axis current reference value Iq_tp in accordance with the control mode, based on the q-axis current reference value Iq_pi. The dq converter 445 may calculate the d-axis current reference value Id_tp and the q-axis current reference value Iq_tp to achieve a corresponding torque by treating the q-axis current reference value Iq_pi as a torque reference value.

The d-axis current reference value Id_tp and the q-axis current reference value Iq_tp calculated by the dq converter 445 are input to the limiter 447.

When the d-axis current reference value Id_tp input from the dq converter 445 is equal to or less than the d-axis current limit value Id_limit, the limiter 447 outputs the d-axis current reference value Id_tp as an output of the speed controller 44. That is, the limiter 447 outputs the d-axis current reference value Id_tp as the above-described d-axis current reference value Id_r.

When the d-axis current reference value Id_tp input from the dq converter 445 exceeds the d-axis current limit value Id_limit, the limiter 447 outputs the d-axis current limit value Id_limit as the d-axis current reference value Id_r.

Similarly, when the q-axis current reference value Iq_tp input from the dq converter 445 is equal to or less than the q-axis current limit value Iq_limit, the limiter 447 outputs the q-axis current reference value Iq_tp as the above-described q-axis current reference value Iq_r.

When the q-axis current reference value Iq_tp input from the dq converter 445 exceeds the q-axis current limit value Iq_limit, the limiter 447 outputs the q-axis current limit value Iq_limit as the q-axis current reference value Iq_r.

As described above, the d-axis current reference value Id_r and the q-axis current reference value Iq_r output from the limiter 447 are input to the current controller 47. The d-axis current measurement value Id_m and the q-axis current measurement value Iq_m are further input to the current controller 47.

The current controller 47 is configured to convert the d-axis current reference value Id_r and the q-axis current reference value Iq_r input from the speed controller 44 into a d-axis voltage reference value Vd_r and a q-axis voltage reference value Vq_r. The conversion here may be performed using known techniques, but is not limited thereto.

Specifically, the current controller 47 calculates a d-axis voltage reference value Vd_r and a q-axis voltage reference value Vq_r based on the q-axis current reference value Iq_r, the q-axis current measurement value Iq_m, the d-axis current reference value Id_r, and the d-axis current measurement value Id_m. The current controller 47 inputs the calculated d-axis voltage reference value Vd_r and q-axis voltage reference value Vq_r to the voltage converter 49.

The d-axis voltage reference value Vd_r, the q-axis voltage reference value Vq_r, the battery voltage Vbat, and the rotation angle θ are input to the voltage converter 49. The voltage converter 49 calculates three-phase voltage reference values based on the d-axis voltage reference value Vd_r, the q-axis voltage reference value Vq_r, the battery voltage Vbat, and the rotation angle θ.

The voltage converter 49 converts the d-axis voltage reference value Vd_r and the q-axis voltage reference value Vq_r into the three-phase voltage reference values by, for example, inverse Clarke transformation and inverse Park transformation. The voltage converter 49 outputs the calculated three-phase voltage reference values as the first through sixth drive signals UH, VH, WH, UL, VL, WL to the drive circuit 31 (see FIG. 2), and supplies the three-phase line currents to the motor 6 through the drive circuit 31.

### 2-1-4. Configuration of Limit Value Setter

The limit value setter 45 is configured to (i) set a line current limit value Ia_limit based on the operating state of the work machine 1, (ii) convert the line current limit value Ia_limit into a d-axis current limit value Id_limit and a q-axis current limit value Iq_limit, and (iii) output them.

The line current limit value Ia_limit is a limit value of the line current flowing through the motor 6. The line current corresponds to a current flowing through each of the three-phase lines in the motor 6. The line current limit value Ia_limit may correspond to an upper limit value of the amplitude of the line current.

Specifically, the limit value setter 45 is configured to set a line current limit value Ia_limit based on an input limit Pin_limit, an output limit Pout_limit, and a torque limit Trq_limit. When setting the line current limit value Ia_limit, the limit value setter 45 may be configured to take into account the rotational speed of the motor 6, the temperature Tm, the battery current Ibat, the battery voltage Vbat, and the like.

The input limit Pin_limit, the output limit Pout_limit, and the torque limit Trq_limit correspond to constraint parameters. The input limit Pin_limit is a constraint on input energy from the battery 15a. The input limit Pin_limit corresponds to an upper limit of the input energy from the battery 15a to the motor 6. The input limit Pin_limit can be expressed by the following equation: Pin_limit=Vbat·Ibat_limit, using the battery voltage Vbat and the upper limit Ibat_limit of the battery current.

The battery current upper limit Ibat_limit may correspond to an allowable maximum current of the battery 15a. The input limit Pin_limit may change depending on the battery 15a attached to the work machine 1. That is, the input limit Pin_limit changes based on the state of the work machine 1.

The output limit Pout_limit is a constraint on output energy caused by the capability of the motor 6. The output limit Pout_limit corresponds to an upper limit of the output energy. The torque limit Trq_limit is a constraint on output torque caused by the capability of the motor 6. The torque limit Trq_limit corresponds to an upper limit of the output torque. The output limit Pout_limit and the torque limit Trq_limit are determined based on the performance of the motor 6 mounted on the work machine 1.

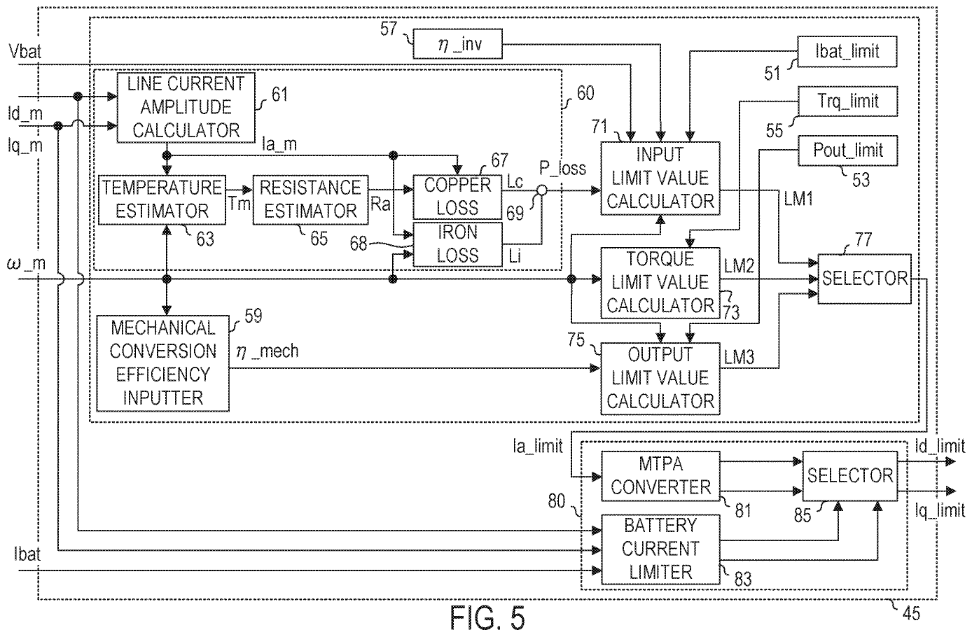

FIG. 5 shows a detailed configuration of the limit value setter 45. The limit value setter 45 includes an input limit inputter 51 configured to input the battery current upper limit Ibat_limit for calculating the input limit Pin_limit, an output limit inputter 53 configured to input the output limit Pout_limit, and a torque limit inputter 55 configured to input the torque limit Trq_limit.

The limit value setter 45 further includes an inverter efficiency inputter 57 configured to input an inverter efficiency η_inv, and a mechanical conversion efficiency inputter 59 configured to input a mechanical conversion efficiency η_mech. The inverter efficiency η_inv indicates a ratio η_inv=Pmtr/Pin of an output energy Pmtr to an input energy Pin supplied to the inverter (drive circuit 31). For example, the inverter efficiency η_inv is set as a fixed value for the inverter (drive circuit 31).

The mechanical conversion efficiency η_mech indicates a ratio η_mech=Pout/Pmtr of an output energy Pout to the input energy Pmtr supplied to the motor 6. The output energy Pout may be calculated by, for example, torque×angular velocity. The mechanical conversion efficiency inputter 59 may calculate the mechanical conversion efficiency η_mech based on the speed measurement value ω_m input from the position/speed calculator 41.

The limit value setter 45 further includes a loss calculator 60, an input limit value calculator 71, a torque limit value calculator 73, an output limit value calculator 75, a first selector 77, and a limit value converter 80.

The loss calculator 60 is configured to calculate an energy loss that is not converted into mechanical output out of input to the motor 6. The energy loss includes a copper loss and an iron loss. The loss calculator 60 includes a line current amplitude calculator 61, a temperature estimator 63, a resistance estimator 65, a copper loss estimator 67, an iron loss estimator 68, and a motor loss estimator 69.

The line current amplitude calculator 61 is configured to calculate an amplitude Ia_m of the line current based on the d-axis current measurement value Id_m and the q-axis current measurement value Iq_m input from the current converter 42. The amplitude Ia_m of the line current may be understood as a magnitude of a current vector (Id_m, Iq_m). The line current amplitude calculator 61 inputs the calculated line current amplitude Ia_m to the temperature estimator 63.

The temperature estimator 63 is configured to estimate the temperature Tm of the motor 6. Specifically, the temperature estimator 63 (i) estimates the temperature Tm of the motor 6 based on the line current amplitude Ia_m and the speed measurement value ω_m input from the position/speed calculator 41, and (ii) inputs the estimated temperature Tm of the motor 6 to the resistance estimator 65 as a motor temperature Tm. The temperature estimator 63 may (i) receive, from the second temperature detection circuit 23, an input of the second temperature detection signal Stm indicating the temperature of the motor 6 detected by the second temperature detection circuit 23, and (ii) input, as the motor temperature Tm, the temperature indicated by the second temperature detection signal Stm to the resistance estimator 65.

The resistance estimator 65 estimates the resistance Ra of the motor 6 based on the motor temperature Tm input from the temperature estimator 63. The resistance estimator 65 inputs the estimated resistance Ra of the motor 6 to the copper loss estimator 67 as a motor resistance Ra.

The copper loss estimator 67 estimates the copper loss in the motor 6, that is, an electric power loss caused by the motor resistance Ra, based on the motor resistance Ra input from the resistance estimator 65 and the line current amplitude Ia_m input from the line current amplitude calculator 61. The copper loss estimator 67 inputs the estimated copper loss to the motor loss estimator 69 as a loss Lc.

The iron loss estimator 68 estimates the iron loss in the motor 6, that is, an electric power loss caused by a change in magnetic field, based on the line current amplitude Ia_m input from the line current amplitude calculator 61 and the speed measurement value ω_m input from the position/speed calculator 41. The iron loss estimator 68 inputs the estimated iron loss to the motor loss estimator 69 as a loss Li.

The iron loss estimator 68 may have a table (not shown) in which every combination of possible values of the line current amplitude Ia_m and the speed measurement value ω_m is associated with the loss Li. The iron loss estimator 68 may refer to the table and input, to the motor loss estimator 69, the loss Li based on the line current amplitude Ia_m and the speed measurement value ω_m.

The motor loss estimator 69 is configured to output a sum of the received loss Lc and loss Li (Lc+Li) as the energy loss in the motor 6, that is, as a motor loss P_loss. The motor loss P_loss output from the motor loss estimator 69 is input to the input limit value calculator 71.

The input limit value calculator 71 receives the battery current upper limit Ibat_limit from the input limit inputter 51, the inverter efficiency η_inv from the inverter efficiency inputter 57, the battery voltage Vbat from the battery voltage detection circuit 34, the motor loss P_loss from the loss calculator 60, and the speed measurement value ω_m from the position/speed calculator 41.

The input limit value calculator 71 calculates a first limit value LM1 based on the battery current upper limit Ibat_limit, the inverter efficiency η_inv, the battery voltage Vbat, the motor loss P_loss, and the speed measurement value ω_m. The first limit value LM1 is an upper limit of the line current Ia resulting from the constraint on input energy, that is, the input limit Pin_limit=Vbat·Ibat_limit.

As is well known, the output energy Pout of the motor 6 is calculated by multiplying the torque τ and the angular velocity ω of the motor 6: Pout=τ·ω. The torque τ is expressed by the following equation: τ=pn·Ia·Ψa, using the line current Ia of the motor 6, the back-EMF constant Ψa, and the number of stator pole pairs pn.

When the inverter efficiency η_inv, the motor efficiency η_mtr, and the input energy Pin to the motor 6 are used, the mechanical output of the motor 6 is expressed by the following equation: Pin·η_inv·η_mtr=Pin·η_inv−P_loss. That is, the equation Pin·η_inv−P_loss=pn·Ia·Ψa·ω.

In the above equation, when the input energy Pin is replaced with the input limit=Pin_limit=Vbat·Ibat_limit, and the line current Ia is replaced with the line current upper limit (LM1), the line current upper limit (LM1) can be calculated by the following equation.

LM1={Vbat·Ibat_limit·η_inv−P_loss}/(pn·Ψa·ω_m)

As described above, ω_m is the speed measurement value of the motor 6, and is a measurement value of the angular velocity ω. The input limit value calculator 71 calculates the first limit value LM1 in accordance with this equation. The input limit value calculator 71 inputs the calculated first limit value LM1 to a first selector 77. In the above equation, the number of stator pole pairs pn and the back-EMF constant Ψa are constants specific to the motor 6.

The torque limit value calculator 73 calculates a second limit value LM2 based on the torque limit Trq_limit and the speed measurement value ω_m. The second limit value LM2 is an upper limit of the line current Ia based on a constraint on torque. The torque limit value calculator 73 receives the torque limit Trq_limit from the torque limit inputter 55 and the speed measurement value ω_m from the position/speed calculator 41.

As described above, the torque τ is expressed by the following equation: τ=pn·Ia·Ψa. In this equation, when the torque τ is replaced with the torque limit Trq_limit, and the line current Ia is replaced with the line current upper limit (LM2), the line current upper limit (LM2) corresponding to the torque limit Trq_limit can be calculated by the following equation.

LM2=Trq_limit/(pn·Ψa)

The torque limit value calculator 73 calculates the second limit value LM2 in accordance with this equation. The torque limit value calculator 73 inputs the calculated second limit value LM2 to the first selector 77. The second limit value LM2 is an upper limit of the line current that, if exceeded, may cause coil burnout of the motor 6 or thermal destruction of the switching element (MOSFET).

The output limit value calculator 75 calculates a third limit value LM3 based on the output limit Pout_limit and the speed measurement value ω_m. The third limit value LM3 is an upper limit of the line current Ia based on a constraint on output energy. The output limit value calculator 75 receives the output limit Pout_limit from the output limit inputter 53 and the speed measurement value ω_m from the position/speed calculator 41.

The output energy Pout of the motor 6 can be calculated by the following equation Pout=τ·ω=pn·Ia·Ψa·ω. In this equation, when the output energy Pout is replaced with the output limit Pout_limit, and the line current Ia is replaced with the line current upper limit (LM3), the line current upper limit (LM3) corresponding to the output limit Pout_limit can be calculated by the following equation.

LM3=Pout_limit/(pn·Ψa·ω_m)

The output limit value calculator 75 calculates the third limit value LM3 in accordance with this equation. The output limit value calculator 75 inputs the calculated third limit value LM3 to the first selector 77.

In another example, the output limit value calculator 75 may further receive the mechanical conversion efficiency η_mech from the mechanical conversion efficiency inputter 59. When the mechanical conversion efficiency η_mech is taken into consideration, the output energy Pout of the motor 6 is expressed by the following equation: Pout=η_mech·pn·Ia·Ψa·ω.

The output limit value calculator 75 may calculate the line current upper limit (LM3) corresponding to the output limit Pout_limit by the following equation in consideration of the mechanical conversion efficiency η_mech.

LM3=Pout_limit/(η_mech·pn·Ψa·ω_m)

In another example, the output limit value calculator 75 may calculate the third limit value LM3 in consideration of the mechanical conversion efficiency η_mech in accordance with this equation, and input the calculated third limit value LM3 to the first selector 77.

The first selector 77 is configured to select and output, as the line current limit value Ia_limit, a minimum value among the first limit value LM1 input from the input limit value calculator 71, the second limit value LM2 input from the torque limit value calculator 73, and the third limit value LM3 input from the output limit value calculator 75. The line current limit value Ia_limit output from the first selector 77 is input to a limit value converter 80.

The limit value converter 80 is configured to convert the line current limit value Ia_limit input from the first selector 77 into a d-axis current limit value Id_limit and a q-axis current limit value Iq_limit, and to output the d-axis current limit value Id_limit and the q-axis current limit value Iq_limit.

As shown in FIG. 5, the limit value converter 80 includes an MTPA converter 81, a battery current limiter 83, and a second selector 85. The MTPA converter 81 includes an MTPA table (not shown) describing a d-axis current and a q-axis current for achieving a maximum torque with respect to a line current. According to the MTPA table, the MTPA converter 81 is configured to output values of the d-axis current and the q-axis current that achieve the maximum torque with respect to the line current limit value Ia_limit, as d-axis and q-axis current upper limit values. The d-axis and q-axis current upper limit values output from the MTPA converter 81 are input to the second selector 85.

The battery current limiter 83 is configured to output upper limit values of the d-axis current and the q-axis current in consideration of the battery current Ibat, based on the battery current Ibat, the d-axis current measurement value Id_m, and the q-axis current measurement value Iq_m.

Regarding the d-axis current and the q-axis current, the second selector 85 outputs the smaller of the upper limit values input from the MTPA converter 81 and the upper limit values input from the battery current limiter 83 as the d-axis current limit value Id_limit and the q-axis current limit value Iq_limit. The d-axis current limit value Id_limit and the q-axis current limit value Iq_limit output from the second selector 85 are input to the speed controller 44.

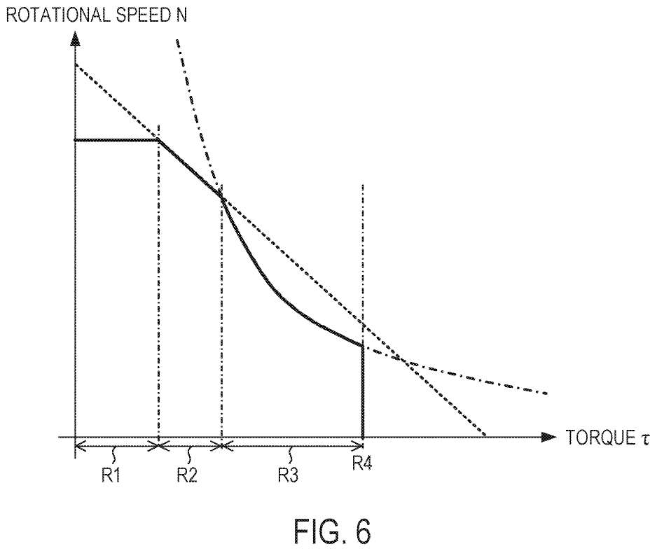

The speed controller 44 controls the motor 6 based on the d-axis current limit value Id_limit and the q-axis current limit value Iq_limit set in this manner. As a result, the rotation speed and torque of the motor 6 vary as shown in FIG. 6.

FIG. 6 is a graph having a horizontal axis of torque τ and a vertical axis of rotational speed N. FIG. 6 shows, by a thick solid line, an N-T characteristic curve indicating a relationship between the torque τ and the rotational speed N achieved by the control on the motor 6. The N-T characteristic curve referred to here means a characteristic curve representing the relationship between the rotational speed N and the torque τ (in other words, torque T) of the motor 6.

The N-T characteristic curve shown in FIG. 6 indicates the relationship between the torque τ and the rotational speed N when the pull amount of the trigger 10 is constant (for example, a maximum pull amount) and a constant speed reference value ω_r based on the pull amount is input from the speed reference generator 43. In this case, in a situation where a load on the motor 6 is small, the rotational speed N of the motor 6 is maintained constant (a region R1 shown in FIG. 6).

Thereafter, when the load increases and the torque τ to be achieved in the motor 6 increases, the voltage corresponding to the current reference values (Id_r, Iq_r) reaches the upper limit of the output voltage of the inverter (drive circuit 31), and the motor 6 achieves the required torque for the load while decreasing the rotational speed N (a region R2 shown in FIG. 6). At this time, the torque τ and the rotational speed N are in a proportional relationship. That is, the rotational speed N decreases at a constant slope with respect to an increase in the torque τ.

When the load applied to the motor 6 increases and the required torque further increases, the speed controller 44 performs a constant output control on the motor 6 under a constraint on input energy or output energy (a region R3 shown in FIG. 6). This constant output control is achieved as follows. The d-axis current limit value Id_limit and the q-axis current limit value Iq_limit corresponding to the first limit value LM1 or the third limit value LM3 are input to the speed controller 44, and the d-axis current reference value Id_r and the q-axis current reference value Iq_r output from the speed controller 44 are set to the d-axis current limit value Id_limit and the q-axis current limit value Iq_limit.

At this time, the rotational speed N shows an inversely proportional relationship to the torque τ. This is because the output energy corresponds to a product of the torque τ and the rotational speed N (in other words, the angular velocity ω).

When the load applied to the motor 6 further increases and the required torque further increases, the speed controller 44 performs a process of controlling the motor 6 such that the torque of the motor 6 does not exceed a specified value under a constraint on motor torque, that is, performs a torque limitation (a point R4 shown in FIG. 6). This torque limitation is achieved as follows. The d-axis current limit value Id_limit and the q-axis current limit value Iq_limit corresponding to the second limit value LM2 are input to the speed controller 44, and the d-axis current reference value Id_r and the q-axis current reference value Iq_r output from the speed controller 44 are set to the d-axis current limit value Id_limit and the q-axis current limit value Iq_limit.

In this manner, the work machine 1 of the present embodiment sets, as the line current limit value Ia_limit, the minimum value among the limit values LM1, LM2, and LM3, wherein the limit values LM1 and LM3 are based on energy constraints and the limit value LM2 is based on a torque constraint. The work machine 1 outputs the d-axis current reference value Id_r and the q-axis current reference value Iq_r based on the d-axis current limit value Id_limit and the q-axis current limit value Iq_limit such that the line current Ia flowing through the motor 6 does not exceed the line current limit value Ia_limit. Thus, the work machine 1 can operate stably against an increase in load while exhibiting the maximum capability of the motor 6.

That is, it is possible to suppress a degradation of usability caused by an emergency stop of the work machine 1 due to an error resulting from an overcurrent or an overload caused by execution of motor control based on the d-axis current reference value Id_r and the q-axis current reference value Iq_r that do not match the state of the work machine 1. Further, it is possible to suppress thermal damage such as coil burnout.

The operation of the control circuit 30 has been described above using the functional blocks. Subsequently, the operation of the control circuit 30 will be described using a flowchart.

### 2-1-5. Processing in Control Circuit

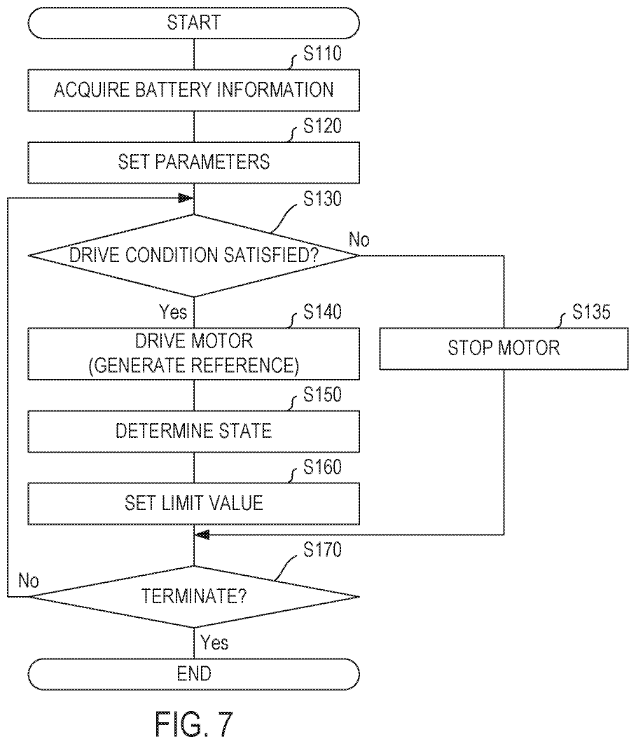

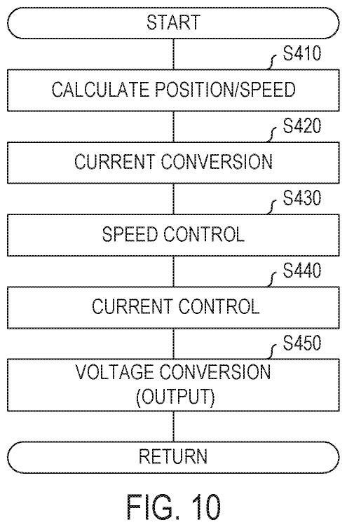

The processor 30a of the control circuit 30 performs a main process shown in FIG. 7. A loop in the main process (processing of S130 to S170 to be described later) is performed at a first frequency, e.g., a frequency of 1 kHz. Separately from this main process, the processor 30a performs an interrupt process shown in FIG. 10. The interrupt process is performed at a second frequency higher than the first frequency, for example, a frequency of 20 kHz.

### 2-1-5-1. Main Process

The processor 30a starts the main process upon activation of the work machine 1. Upon starting the main process, the processor 30a communicates with the battery pack 15 and acquires battery information (S110). The battery information includes information on an internal impedance, an overcurrent threshold, an overload threshold, and a battery type. The information on the battery type may include information on a model and a capacity of the battery. The battery information may further include information on remaining capacity, battery temperature, battery voltage, and battery current.

In subsequent S120, the processor 30a sets, as parameters used for setting the line current limit value Ia_limit, the battery current upper limit Ibat_limit, the torque limit Trq_limit, the output limit Pout_limit, and the inverter conversion efficiency η_inv.

This setting is performed based on machine information of the work machine 1 stored in the memory 30b. As described above, the work machine 1 is configured such that the battery pack 15 is replaceable. That is, multiple types of battery packs 15 can be attached to the work machine 1 by replacement.

Therefore, the processor 30a sets the battery current upper limit Ibat_limit corresponding to a battery current that can be supplied by the battery pack 15 attached to the work machine 1, based on the information on the battery type obtained through communication with the battery pack 15. The battery current upper limit Ibat_limit may be set in consideration of the battery temperature.

In subsequent S130, the processor 30a determines whether a drive condition is satisfied. The processor 30a may determine that the drive condition is satisfied when a trigger switch (not shown) is switched to ON by a pull operation of the trigger 10 in a state where drive permission is granted from a protection circuit.

When determining that the drive condition is not satisfied (No in S130), the processor 30a stops the motor 6 or maintains a stopped state of the motor 6 (S135). Thereafter, the process proceeds to the processing of S170.

When determining that the drive condition is satisfied (Yes in S130), the processor 30a instructs the speed controller 44 to drive the motor 6 (S140). The processor 30a may instruct the speed controller 44 to drive the motor 6 by generating and outputting the speed reference value ω_r based on the pull amount of the trigger 10. The generation and output of the speed reference value ω_r correspond to the processing achieved by the speed reference generator 43 described above.

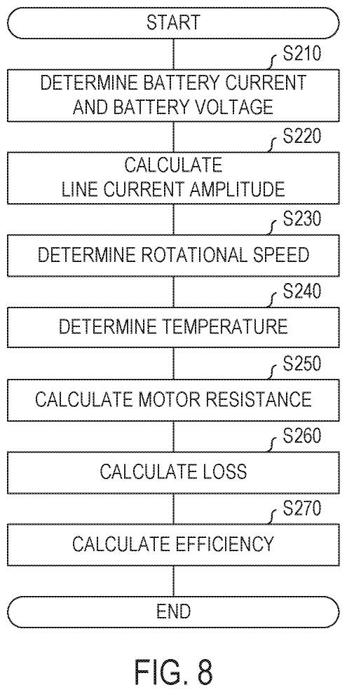

In subsequent S150, the processor 30a performs a state determination process. Details of the state determination process are shown in FIG. 8. Upon starting the state determination process, the processor 30a determines the battery current Ibat and the battery voltage Vbat (S210). In subsequent S220, the processor 30a calculates the line current amplitude Ia_m. The calculation of the line current amplitude Ia_m corresponds to the processing achieved by the line current amplitude calculator 61 described above.

In subsequent S230, the processor 30a performs a speed determination process. The processor 30a may perform, as the speed determination process, processing of calculating the rotational speed N, i.e., the speed measurement value ω_m of the motor 6. The processing of calculating the speed measurement value ω_m corresponds to the processing achieved by the position/speed calculator 41 described above.

In subsequent S240, the processor 30a performs a temperature determination process. In the temperature determination process, the processor 30a may determine the battery temperature, the motor temperature, and the inverter temperature.

The processor 30a may determine the battery temperature based on the battery information. The processor 30a may estimate the motor temperature Tm from the line current amplitude Ia_m and the speed measurement value ω_m. That is, the processor 30a may determine the motor temperature Tm by estimation. The processor 30a may determine the motor temperature Tm based on the second temperature detection signal Stm. The processor 30a may determine the inverter temperature based on the first temperature detection signal Std. The estimation of the motor temperature corresponds to the processing achieved by the temperature estimator 63 described above.

In subsequent S250, the processor 30a performs a motor resistance calculation process. The processor 30a may estimate the motor resistance Ra based on the motor temperature Tm. That is, the processor 30a may determine the motor resistance Ra by estimation. The estimation of the motor resistance Ra corresponds to the processing achieved by the resistance estimator 65 described above.

In subsequent S260, the processor 30a performs a loss calculation process. The processor 30a may calculate the motor loss P_loss based on the motor resistance Ra, the line current amplitude Ia_m, and the speed measurement value ω_m. The calculation of the motor loss P_loss corresponds to the processing achieved by the copper loss estimator 67, the iron loss estimator 68, and the motor loss estimator 69 described above.

In subsequent S270, the processor 30a performs an efficiency determination process. In the efficiency determination process, the processor 30a may determine the mechanical conversion efficiency η_mech by calculating it based on the speed measurement value ω_m.

The processor 30a may determine the inverter efficiency η_inv by reading out the inverter efficiency η_inv stored in the memory 30b. The calculation of the mechanical conversion efficiency η_mech corresponds to the processing achieved by the mechanical conversion efficiency inputter 59. In this manner, the processor 30a performs the state determination process (S150), and upon terminating the state determination process, performs the processing of S160.

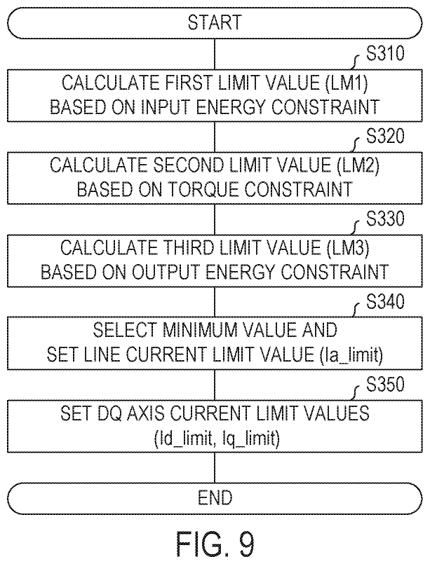

In S160, the processor 30a performs a limit value setting process. The limit value setting process is shown in FIG. 9. Upon starting the limit value setting process, the processor 30a calculates the first limit value LM1, which is a limit value of the line current based on the input energy constraint, in S310. As described above, the first limit value LM1 is calculated based on the battery current upper limit Ibat_limit, the inverter efficiency η_inv, the battery voltage Vbat, the motor loss P_loss, and the speed measurement value ω_m. The calculation of the first limit value LM1 corresponds to the processing achieved by the input limit value calculator 71 described above.

In subsequent S320, the processor 30a calculates the second limit value LM2, which is a limit value of the line current based on the torque constraint. As described above, the second limit value LM2 is calculated based on the torque limit Trq_limit and the speed measurement value ω_m. The calculation of the second limit value LM2 corresponds to the processing achieved by the torque limit value calculator 73 described above.

In subsequent S330, the processor 30a calculates the third limit value LM3, which is a limit value of the line current based on the output energy constraint. As described above, the third limit value LM3 is calculated based on the output limit Pout_limit, the speed measurement value ω_m, and optionally further based on the mechanical conversion efficiency η_mech. The calculation of the third limit value LM3 corresponds to the processing achieved by the output limit value calculator 75 described above.

In subsequent S340, the processor 30a sets, as the line current limit value Ia_limit the minimum value among the first limit value LM1, the second limit value LM2, and the third limit value LM3. The setting of the line current limit value Ia_limit corresponds to the processing achieved by the first selector 77 described above.

In subsequent S350, the processor 30a sets the d-axis current limit value Id_limit and the q-axis current limit value Iq_limit corresponding to the line current limit value Ia_limit by converting the line current limit value Ia_limit into the d-axis current limit value Id_limit and the q-axis current limit value Iq_limit. This conversion corresponds to the processing achieved by the limit value converter 80 described above. In this manner, the processor 30a performs the limit value setting process (S160).

Upon terminating the limit value setting process in S160, the processor 30a performs the processing of S170. In S170, the processor 30a determines whether a termination condition of the main process is satisfied. The termination condition of the main process is satisfied, for example, when an off-operation of the work machine 1 is performed via the power switch 12a.

When determining that the termination condition of the main process is not satisfied (No in S170), the processor 30a proceeds to the processing of S130. In this manner, the processor 30a repeatedly performs the processing of S130 to S170 at the first frequency until the termination condition is satisfied. If the termination condition is satisfied (Yes in S170), the processor 30a ends the main process.

### 2-1-5-2. Interrupt Process

Upon starting the interrupt process shown in FIG. 10, the processor 30a performs a position/speed calculation process for the motor 6 in S410. In the position/speed calculation process, the processor 30a calculates the rotation angle θ and the speed measurement value ω_m of the motor 6. The position/speed calculation process corresponds to the processing achieved by the position/speed calculator 41 described above.

In subsequent S420, the processor 30a performs a current conversion process for the motor 6. In the current conversion process, the processor 30a acquires measurement values of the U-, V-, and W-phase line currents of the motor 6 by sampling the U-, V-, and W-phase line current detection signals Siu, Siv, and Siw input from the first to third current detection circuits 36, 37, and 38. The processor 30a converts the acquired measurement values of the three-phase line currents into d-q axis currents (Id_m, Iq_m). The current conversion process corresponds to the processing achieved by the current converter 42 described above.

In subsequent S430, the processor 30a performs a speed control process for the motor 6. In the speed control process, the processor 30a generates a torque reference value (q-axis current reference value Iq_pi) through PI control based on the deviation E between the speed reference value ω_r and the speed measurement value ω_m. The deviation E is expressed by the following equation: E=ω_r−ω_m.

The processor 30a converts this torque reference value (Iq_pi) into the d-axis current reference value Id_r and the q-axis current reference value Iq_r. At this time, the processor 30a converts the torque reference value (Iq_pi) into the d-axis current reference value Id_r and the q-axis current reference value Iq_r within a range not exceeding the set d-axis current limit value Id_limit and q-axis current limit value Iq_limit. The speed control process corresponds to the processing achieved by the speed controller 44 described above.

In subsequent S440, the processor 30a performs a current control process. In the current control process, the processor 30a converts the d-axis current reference value Id_r and the q-axis current reference value Iq_r into the d-axis voltage reference value Vd_r and the q-axis voltage reference value Vq_r. The current control process corresponds to the processing achieved by the current controller 47 described above.

In subsequent S450, the processor 30a performs a voltage conversion process. In the voltage conversion process, the processor 30a converts the d-axis voltage reference value Vd_r and the q-axis voltage reference value Vq_r into three-phase voltage reference values. The three-phase voltage reference values calculated by the processor 30a are input to the drive circuit 31 (see FIG. 2) as the first through sixth drive signals UH, VH, WH, UL, VL, and WL. Thus, three-phase line currents are supplied to the motor 6 through the drive circuit 31.

In this manner, the processor 30a controls the motor 6 through the interrupt process. Specifically, the processor 30a drives the motor 6 by FOC in accordance with the d-axis current limit value Id_limit and the q-axis current limit value Iq_limit such that the line current of the motor 6 does not exceed the line current limit value Ia_limit. Thus, the processor 30a controls the rotational speed N and the torque τ so as to achieve the N-T characteristic curve shown in FIG. 6. As a result, the processor 30a drives the motor 6 so as to safely exhibit the maximum capability of the motor 6 in response to an in crease in load.

Through the motor control based on the d-axis current limit value Id_limit and the q-axis current limit value Iq_limit, the processor 30a performs the constant rotation control based on the pull amount of the trigger 10 under a low load (region R1 in FIG. 6), and controls the motor 6 so as to proportionally decrease the rotational speed N in response to an increase in the torque τ under a medium load (region R2).

The processor 30a performs the constant output control on the motor 6 under a first high load (region R3), and performs the torque limitation on the motor 6 under a second high load (point R4).

### 2-1-6. Actions and Effects

The speed controller 44 corresponds to an example of a controller configured to control a brushless DC motor (specifically, the motor 6), and the limit value setter 45 corresponds to an example of a setter configured to set the limit value Ia_limit of the line current input to the brushless DC motor (specifically, the motor 6).

In the present embodiment, the speed controller 44 outputs the current reference values Id_r and Iq_r that are set by the limiter 447 and that do not exceed the limit values Id_limit and Iq_limit, thereby driving the motor 6 through FOC such that a line current equal to or less than the limit value Ia_limit set by the limit value setter 45 is input to the motor 6.

The limit value setter 45 sets, as the state of the work machine 1, the first limit value LM1 based on the battery current upper limit Ibat_limit depending on the battery 15a attached to the work machine 1, specifically, depending on the type of the battery 15a.

The limit value setter 45 sets, as the state of the work machine 1, the third limit value LM3 based on the output upper limit of the motor 6, i.e., the output limit Pout_limit. The limit value setter 45 sets, as the state of the work machine 1, the second limit value LM2 based on the torque upper limit of the motor 6, i.e., the torque limit Trq_limit.

The limit value setter 45 estimates the temperature Tm of the motor 6 as the state of the work machine 1, and sets the first limit value LM1 based on the motor temperature Tm. The limit value setter 45 estimates the loss (P_loss) of electric power input to the motor 6, and sets the first limit value LM1 in consideration of the loss (P_loss). The limit value setter 45 estimates the motor resistance Ra based on the motor temperature Tm, and estimates the loss (P_loss) from the motor resistance Ra.

The limit value setter 45 sets, as the state of the work machine 1, the first, second, and third limit values LM1, LM2, and LM3 based on the rotational speed (ω_m) of the motor 6.

The limit value setter 45 sets, as the limit value Ia_limit, the minimum value among the first, second, and third limit values LM1, LM2, and LM3.

In this manner, the limit value setter 45 appropriately sets the limit value Ia_limit of the line current of the motor 6 based on the state of the work machine 1. This allows the work machine 1 of the present embodiment to reduce the occurrence of a situation where the capability of the motor 6 cannot be effectively utilized due to the limit value Ia_limit being lower than the actual limit. Furthermore, it is also possible to drive the motor 6 so as to exhibit the maximum capability of the motor 6 while ensuring safety. Therefore, in the present embodiment, it is possible to provide a high-performance work machine 1 capable of safely and stably operating at a high output even under a high load.

In particular, by setting the limit value Ia_limit described above, the speed controller 44 operates to perform the constant rotation control on the motor 6 such that the motor 6 rotates at a constant speed in response to the pull operation of the trigger 10 (region R1 in FIG. 6), and to perform the constant output control (region R3) and the torque limitation (point R4) in response to an increase in the load applied to the motor 6.

The torque limitation is achieved as follows. In an environment in which the limit value setter 45 sets, as the line current limit value Ia_limit, the limit value LM2 based on the torque upper limit Trq_limit, the motor 6 is driven such that the line current corresponding to the limit value Ia_limit is input to the motor 6. The torque limitation limits the torque of the motor 6 so as not to exceed a specified torque.

The constant output control is achieved as follows. In an environment in which the limit value setter 45 sets, as the line current limit value Ia_limit, the limit value LM1 based on the battery current upper limit Ibat_limit or the limit value LM3 based on the output upper limit Pout_limit, the motor 6 is driven such that the line current corresponding to the limit value Ia_limit is input to the motor 6.

In response to an increase in the load applied to the motor 6, in a first stage, the speed controller 44 performs the constant output control on the motor 6 (region R3) such that the rotational speed N of the motor 6 varies in inverse proportion to the torque τ of the motor 6. In a second stage, the speed controller 44 performs the torque limitation on the motor 6 (point R4) such that the torque τ of the motor 6 does not exceed a specified value regardless of the rotational speed N of the motor 6.

Therefore, the work machine 1 of the present embodiment can carry out an operation (e.g., a cutting operation) on a target (e.g., a workpiece) by exhibiting the maximum capability of the motor 6 while ensuring safety and stability in the process where the load applied to the motor 6 increases. The safety in this context includes a property of the work machine 1 that allows the work machine 1 to operate without causing an emergency stop due to an overcurrent or thermal damage to the components inside the work machine 1.

### 2-2. First Modification

In the main embodiment, the control circuit 30 sets the second limit value LM2 based on the constant torque limit Trq_limit independent of the rotational speed (ω_m) of the motor 6 (the process of S320 and the torque limit value calculator 73).

However, the control circuit 30 may be configured to set the second limit value LM2 based on a torque limit Trq_limit_w dependent on the rotational speed of the motor 6, instead of the constant torque limit Trq_limit. That is, the control circuit 30 may be configured to perform the torque limitation on the motor 6 under a high load such that the torque of the motor 6 varies with the rotational speed of the motor 6.

For example, the control circuit 30 may be configured to perform the torque limitation on the motor 6 under a high load such that the torque of the motor 6 varies monotonically with the rotational speed of the motor 6.

For example, the control circuit 30 may be configured to perform the torque limitation on the motor 6 under a high load such that the torque of the motor 6 monotonically increases or monotonically decreases with the rotational speed of the motor 6. The “monotonic increase” and “monotonic decrease” in this context should be interpreted in a broad sense. The “monotonic increase” and “monotonic decrease” may be interpreted as a monotonic non-decrease and a monotonic non-increase, respectively.

For example, the control circuit 30 may be configured to perform the torque limitation on the motor 6 under a high load such that the torque of the motor 6 varies with the rotational speed of the motor 6 in accordance with a quadratic curve or an approximate curve. The approximate curve includes a piecewise linear approximation of a quadratic curve.

For example, the control circuit 30 may be configured to perform the torque limitation on the motor 6 under a high load such that the torque of the motor 6 varies linearly with the rotational speed of the motor 6.

For example, in the process of S320 or in the torque limit value calculator 73, the control circuit 30 may set the second limit value LM2 by using a torque limit Trq_limit_w instead of the torque limit Trq_limit. The torque limit Trq_limit_w is expressed by the following equation: Trq_limit_w=Trq_limit−k·(ω0−ω_m), which is obtained by adding a correction term k·(ω0−ω_m) to the torque limit Trq_limit that is independent of the rotational speed of the motor 6. Here, ω0 corresponds to the rotational speed of the motor 6 at the point where the constant output control is terminated (point R4).

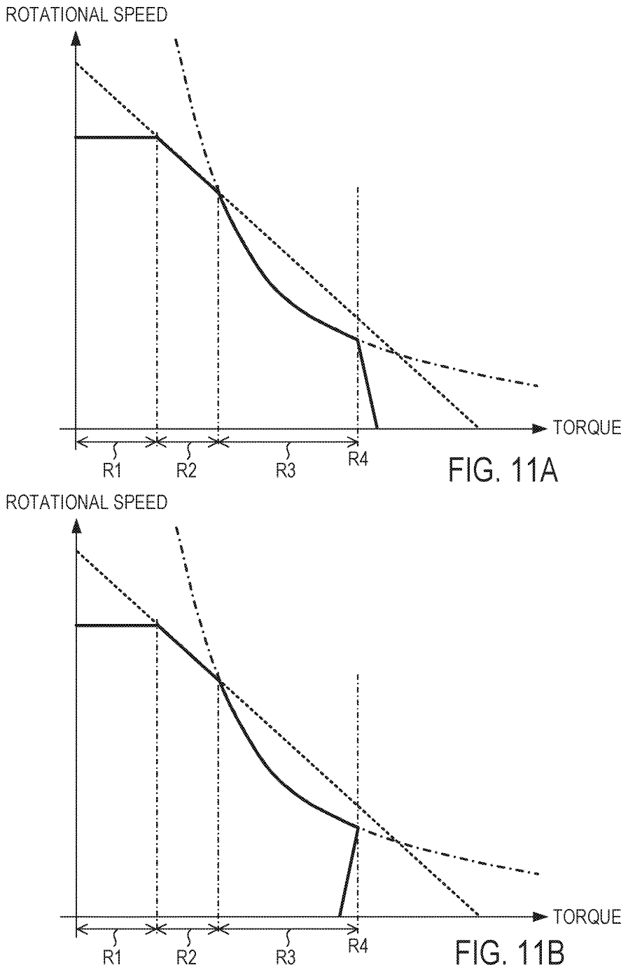

In this case, as shown in FIGS. 11A and 11B, under a second high load following a first high load (region R3), the control circuit 30 performs a torque limitation that varies the torque τ according to the rotational speed N, instead of the torque limitation that limits the torque of the motor 6 to a specified value. FIG. 11A shows, by a thick line, a locus of the torque τ and the rotational speed N particularly when the coefficient k is positive. FIG. 11B shows, by a thick line, a locus of the torque τ and the rotational speed N particularly when the coefficient k is negative. Adjusting the coefficient k modifies the operational feel of the work machine 1 experienced by the user under a high load. As in the main embodiment, the coefficient k may be set to zero.

The control circuit 30 may be configured to receive a selection of the coefficient k from the user as a selection of an operation mode, for example, and to set a value of the coefficient k in accordance with the operation mode designated by the user. The work machine 1 may be configured to receive the selection of the operation mode from the user through the power switch 12a.

That is, the power switch 12a may function as a mode selection switch. For example, the control circuit 30 may recognize a long press of the power switch 12a as an on/off operation of the power supply, and a short press thereof as switching of the operation mode.

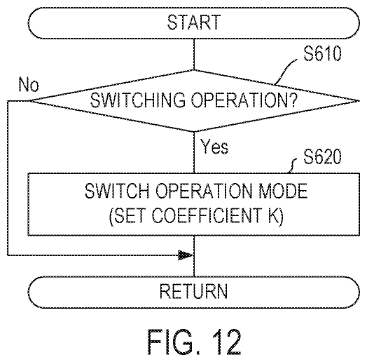

The processor 30a may receive the switching of the operation mode from the user by repeatedly executing the process shown in FIG. 12. The processor 30a determines whether the switching of the operation mode has been performed (S610). When determining that the switching of the operation mode has been performed (Yes in S610), the processor 30a may set the value of the coefficient k to a value defined for the operation mode selected by the switching (S620). The memory 30b may store a table describing the values of the coefficient k to be set for each operation mode. The processor 30a may set the value of the coefficient k by referring to this table.

In this way, switching the value of the coefficient k in response to the mode selection adjusts the operational feel of the work machine 1 under a high load depending on the user's preference. It may be understood that the work machine 1 of the first modification described above is configured similarly to the main embodiment except for the points described above.

### 2-3. Second Modification

The control circuit 30 may be configured to set the line current limit value Ia_limit in consideration of the inverter temperature. In the work machine 1 of the second modification described below, the limit value setter 45 of the control circuit 30 is configured to set the line current limit value Ia_limit in consideration of the inverter temperature. The work machine 1 of the second modification is configured similarly to the main embodiment except for this point.

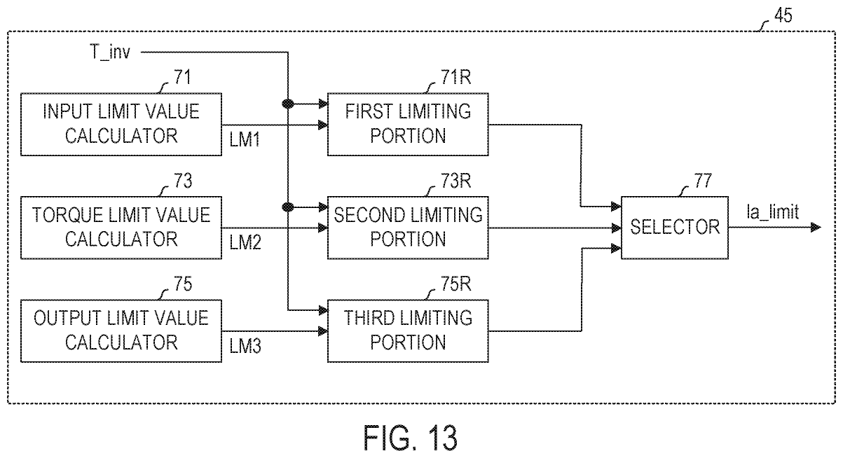

In this modification, the temperature indicated by the first temperature detection signal Std is input to the limit value setter 45 as the inverter temperature T_inv (see FIG. 13).

In this modification, the limit value setter 45 includes a first limiting portion 71R between the input limit value calculator 71 and the first selector 77, a second limiting portion 73R between the torque limit value calculator 73 and the first selector 77, and a third limiting portion 75R between the output limit value calculator 75 and the first selector 77.

The first limiting portion 71R is configured to limit the first limit value LM1 to be input to the first selector 77 based on the inverter temperature T_inv. Specifically, the first limiting portion 71R is configured to set a first current threshold LM1_H based on the inverter temperature T_inv.

The first limiting portion 71R is configured to input the first limit value LM1 to the first selector 77 when the first limit value LM1 input from the input limit value calculator 71 is less than the first current threshold LM1_H. When the first limit value LM1 is equal to or greater than the first current threshold LM1_H, the first limiting portion 71R is configured to change the first limit value LM1 to the first current threshold LM1_H and input the first current threshold LM1_H to the first selector 77 as a new first limit value LM1.

The first limiting portion 71R may have a table describing a relationship between the inverter temperature T_inv and the first current threshold LM1_H to be set. The first limiting portion 71R may refer to the table and set the first current threshold LM1_H based on the inverter temperature T_inv. In an example, the first current threshold LM1_H is set lower as the inverter temperature T_inv increases.

The first limiting portion 71R may be configured to set the first current threshold LM1_H only when the inverter temperature T_inv is equal to or greater than a specified threshold temperature, and not to set the first current threshold LM1_H when the inverter temperature T_inv is less than the threshold temperature. The first current threshold LM1_H may be set to a constant value at or above the threshold temperature. When the inverter temperature T_inv is less than the threshold temperature, the first limiting portion 71R may be configured to input the first limit value LM1 input from the input limit value calculator 71 to the first selector 77 without modification.

Similarly to the first limiting portion 71R, the second limiting portion 73R is also configured to limit the second limit value LM2 to be input to the first selector 77 based on the inverter temperature T_inv. Specifically, the second limiting portion 73R is configured to set a second current threshold LM2_H based on the input inverter temperature T_inv. In an example, the second current threshold LM2_H is also set lower as the inverter temperature T_inv increases.

The second limiting portion 73R is configured to input the second limit value LM2 to the first selector 77 when the second limit value LM2 input from the torque limit value calculator 73 is less than the second current threshold LM2_H. When the second limit value LM2 is equal to or greater than the second current threshold LM2_H, the second limiting portion 73R is configured to change the second limit value LM2 to the second current threshold LM2_H and input the second current threshold LM2_H to the first selector 77 as a new second limit value LM2. Similarly to the first limiting portion 71R, the second limiting portion 73R may be configured to set the second current threshold LM2_H only when the inverter temperature T_inv is equal to or greater than the threshold temperature. The second current threshold LM2_H may be set to a constant value at or above the threshold temperature.

Similarly to the first limiting portion 71R, the third limiting portion 75R is also configured to limit the third limit value LM3 to be input to the first selector 77 based on the inverter temperature T_inv. Specifically, the third limiting portion 75R is configured to set a third current threshold LM3_H based on the input inverter temperature T_inv. In an example, the third current threshold LM3_H may also be set lower as the inverter temperature T_inv increases.

The third limiting portion 75R is configured to input the third limit value LM3 to the first selector 77 when the third limit value LM3 input from the output limit value calculator 75 is less than the third current threshold LM3_H. When the third limit value LM3 is equal to or greater than the third current threshold LM3_H, the third limiting portion 75R is configured to change the third limit value LM3 to the third current threshold LM3_H and input the third current threshold LM3_H to the first selector 77 as a new third limit value LM3. Similarly to the first limiting portion 71R, the third limiting portion 75R may be configured to set the third current threshold LM3_H only when the inverter temperature T_inv is equal to or greater than the threshold temperature, and to limit the third limit value LM3 so as not to exceed the third current threshold LM3_H. The third current threshold LM3_H may be set to a constant value at or above the threshold temperature.

As in this modification, setting the current thresholds LM1_H, LM2_H, and LM3_H based on the inverter temperature T_inv makes it possible to set a more appropriate line current limit value Ia_limit based on the state of the work machine 1, and to effectively utilize the capability of the motor 6.

### 2-4. Other Embodiments

The present disclosure is not limited to the above embodiments, and can take various forms. For example, in the above embodiments, an example has been described in which the technique of the present disclosure is applied to an electric chain saw as the work machine 1. However, the present disclosure is not limited thereto, and can be applied to various electric work machines.

Examples of the electric work machines to which the technique of the present disclosure can be applied include various job-site electric appliances that are used in work sites such as DIY, manufacturing, gardening, and construction and that are configured to be driven by batteries. Specifically, these include electric power tools for masonry work, metalworking, and woodworking; work machines for gardening; and devices for preparing the environment of the work site. More specifically, these include electric blowers, electric hammers, electric hammer drills, electric drills, electric drivers, electric wrenches, electric grinders, electric circular saws, electric reciprocating saws, electric jig saws, electric cutters, electric chain saws, electric planers, electric nailing machines (including tackers), electric hedge trimmers, electric lawn mowers, electric lawn clippers, electric brush cutters, electric cleaners, electric sprayers, electric spreaders, electric dust collectors, laser rangefinders (or laser distance measuring devices), laser markers, laser marker receivers, wall scanners, radios, televisions, speakers, electric coolers/warmers, electric kettles, coffee machines (or coffee makers, or coffee distillers), microwave ovens, robotic vacuum cleaners, battery-powered wheelbarrows, battery-powered bicycles, fan vests, and heating jackets.

The present disclosure is not limited to the aforementioned work machine 1 and the control circuit 30, and may be achieved in various forms. For example, the present disclosure may be achieved in the form of a system including the control circuit 30 as a component, a computer program for making a computer function as the control circuit 30, a non-transitory tangible recording medium such as a semiconductor memory recording this computer program, and a control method.

The present disclosure may be applied to an electric work machine that performs FOC on the motor 6 without using the Hall sensors (the position signal output circuit 21). That is, the present disclosure may be applied to an electric work machine that performs sensorless FOC on the motor 6.

The positions of the first current detection circuit 36, the second current detection circuit 37, and the third current detection circuit 38 are not limited to the first lead wire 26, the second lead wire 27, and the third lead wire 28. The first current detection circuit 36, the second current detection circuit 37, and the third current detection circuit 38 may be provided between the fourth switch Q4 and the ground, between the fifth switch Q5 and the ground, and between the sixth switch Q6 and the ground, respectively.

It is not necessary to detect all of the three-phase line currents (that is, the U-phase line current, the V-phase line current, and the W-phase line current) for FOC on the motor 6,, and only two of the U-phase line current, the V-phase line current, and the W-phase line current may be detected. A single-shunt current detection method using a signal of only a bus current path in the drive circuit 31 may be adopted.

Functions of a single component in the above embodiments may be distributed among a plurality of components. Functions of a plurality of components may be integrated into a single component. A part of the configuration of the above embodiments may be omitted. At least a part of the configuration of the above embodiments may be added to or replaced with the configuration of other embodiments described above. All aspects included in the technical idea specified by the language recited in the claims are embodiments of the present disclosure.

What is claimed is:

1. An electric work machine comprising:
a brushless DC motor for driving a working portion;
a controller configured to control the brushless DC motor; and
a setter configured to set a limit value of a line current,
the controller controlling the brushless DC motor such that a line current equal to or less than the limit value set by the setter is input to the brushless DC motor, and
the setter changing the limit value based on a state of the electric work machine.

2. The electric work machine according to claim 1, wherein the setter is configured to set, as the limit value, a value based on a battery attached to the electric work machine.

3. The electric work machine according to claim 2, wherein the setter is configured to set, as the limit value, a value based on an upper limit of a battery current.

4. The electric work machine according to claim 1, wherein the setter is configured to set, as the limit value, a value based on an upper limit of an output of the brushless DC motor.

5. The electric work machine according to claim 1, wherein the setter is configured to set, as the limit value, a value based on an upper limit of a torque of the brushless DC motor.

6. The electric work machine according to claim 1, wherein the setter is configured to set, as the limit value, a value based on a temperature of the brushless DC motor.

7. The electric work machine according to claim 1, further comprising an inverter, wherein the setter is configured to set, as the limit value, a value based on a temperature of the inverter.

8. The electric work machine according to claim 1, wherein the setter is configured to estimate a loss in electric power to be input to the brushless DC motor, and set the limit value based on the loss.

9. The electric work machine according to claim 8, wherein the setter is configured to estimate the loss based on a resistance of the brushless DC motor.

10. The electric work machine according to claim 9, wherein the setter is configured to estimate the resistance based on a temperature of the brushless DC motor.

11. The electric work machine according to claim 1, wherein the setter is configured to set the limit value based on a rotational speed of the brushless DC motor.

12. The electric work machine according to claim 1, wherein the setter is configured to set, as the limit value, a minimum value among a first limit value, a second limit value, and a third limit value, the first limit value being based on an upper limit of a battery current, the second limit value being based on an upper limit of an output of the brushless DC motor, and the third limit value being based on an upper limit of a torque of the brushless DC motor.

13. The electric work machine according to claim 1, wherein in response to an increase in a load applied to the brushless DC motor, the controller is configured to: (i) perform a constant output control for the brushless DC motor in a first stage such that a rotational speed of the brushless DC motor varies in inverse proportion to a torque of the brushless DC motor, and (ii) perform a torque limitation on the brushless DC motor in a second stage such that the torque of the brushless DC motor does not exceed a specified value regardless of the rotational speed of the brushless DC motor or such that the torque of the brushless DC motor varies monotonically with the rotational speed.

14. The electric work machine according to claim 13, wherein, in an environment in which the setter sets the limit value based on an upper limit of the torque of the brushless DC motor, the torque limitation is achieved by controlling the brushless DC motor such that a line current based on the limit value is input to the brushless DC motor.

15. The electric work machine according to claim 13, wherein, in an environment in which the setter sets the limit value based on an upper limit of a battery current or an upper limit of an output of the brushless DC motor, the constant output control is achieved by controlling the brushless DC motor such that a line current based on the limit value is input to the brushless DC motor.

16. The electric work machine according to claim 13, wherein the controller is configured to: (i) perform a constant rotation control on the brushless DC motor such that the brushless DC motor rotates at a constant speed, and (ii) perform the constant output control and the torque limitation in response to an increase in the load applied to the brushless DC motor.

17. The electric work machine according to claim 1, wherein the controller is configured to drive the brushless DC motor by field-oriented control.
